(19) United States
(12) Patent Application Publication
(10) Pub. No.: US 2025/0356218 A1
(43) Pub. Date: Nov. 20, 2025

(54) SYSTEMS AND METHODS FOR CHAIN OF THOUGHT META-PROMPTING FOR MACHINE LEARNING MODELS

(71) Applicant: THINKABLE HOLDINGS INC., Middletown, DE (US)

(72) Inventor: Mohamed Reda Khyatti, Marbella (ES)

(73) Assignee: THINKABLE HOLDINGS INC., Middletown, DE (US)

(21) Appl. No.: 19/286,863

(22) Filed: Jul. 31, 2025

Related U.S. Application Data
(63) Continuation of application No. PCT/US2024/013384, filed on Jan. 29, 2024.
(60) Provisional application No. 63/442,338, filed on Jan. 31, 2023.

(51) Int. Cl. G06N 5/01

(52) U.S. Cl. CPC G06N 5/01

(57) ABSTRACT

A method, apparatus, and system for performing a task using a chain of thought model. An initiation prompt for execution by at least one machine learning model is provided, including an objective and instructions to define a plurality of agents for achieving the objective and an arrangement of the plurality of agents. A response to the initiation prompt is received defining the plurality of agents and the arrangement of the plurality of agents. The arrangement comprises a hypergraph in which a plurality of nodes represents the plurality of agents, respectively, and a plurality of edges represents data connections between the plurality of agents. A first agent and a second agent are instantiated based on the response. The first agent is represented by a first node of the plurality of nodes in the hypergraph. The second agent is represented by a second node. An output of the second agent is obtained.

### CROSS-REFERENCE

This application is a continuation of PCT Application No. PCT/US2024/013384, filed Jan. 29, 2024, which claims the benefit of and priority to U.S. Provisional Patent Application No. 63/442,338, filed Jan. 31, 2023, the entire content of each of which is hereby incorporated by this reference.

### TECHNICAL FIELD

The disclosed exemplary embodiments relate to machine learning systems and methods and, in particular, to optimizing processing in machine learning models.

### INTRODUCTION

In natural language processing, an artificial intelligence (AI) or machine learning model can enable language understanding and generation. A machine learning model can be directed to perform a variety of tasks by inputting a prompt into the machine learning model. The prompt may specify particular parameters for the machine learning model to follow in completing the task.

A large language model (LLM) is a machine learning model that is trained on a large corpus of text and can be used to generate text. LLMs are capable of learning long-term dependencies between words in a text corpus, which enables the LLM to generate text that is grammatically correct and sounds natural. LLMs are effective at generating text that is realistic and human-like. LLMs can be used in various application, such as translation, text generation, e.g., generating a poem, data extraction, classification, question answering, improving machine translations, etc. LLMs are also effective at generating code and data exchange formats.

Prompt-engineering is a process of creating an input prompt for a machine learning model, e.g., LLM, to use to generate text. In prompt engineering, a seed sentence or phrase may be built to initiate the machine learning model. A typical goal is to get the machine learning model to generate text that is relevant to the prompt and sounds natural. Prompt-engineering can be used by a machine learning model to create text on a variety of topics. For example, a prompt can be engineered to generate descriptions of pictures. Prompts may include a parameter that the machine learning model output shows the step-by-step process used by the machine learning model in performing a task. Prompts may be designed so the machine learning model optimally performs a task and facilitates a better-quality result.

### SUMMARY

The following summary is intended to introduce the reader to various aspects of the detailed description, but not to define or delimit any invention.

In at least one broad aspect, there is provided a method of performing a task using a chain of thought model, the method comprising: providing an initiation prompt for execution by at least one machine learning model, the initiation prompt including an objective and instructions to define a plurality of agents for achieving the objective and an arrangement of the plurality of agents; receiving a response to the initiation prompt generated by the at least one machine learning model, the response defining the plurality of agents and the arrangement of the plurality of agents, wherein the arrangement comprises a hypergraph in which a plurality of nodes represents the plurality of agents, respectively, and in which a plurality of edges represents data connections between the plurality of agents; instantiating a first agent based on the response, the first agent represented by a first node of the plurality of nodes in the hypergraph; instantiating a second agent based on response, the second agent represented by a second node of the plurality of nodes in the hypergraph; and obtaining an output of the second agent.

In some cases, the method further comprises, prior to receiving the response, receiving a preliminary response, wherein the preliminary response to the initiation prompt comprises an intermediate prompt, further comprising providing the intermediate prompt to the at least one machine learning model.

In some cases, the method further comprises requesting a user input based on the preliminary response, and updating the intermediate prompt based on the user input prior to providing the intermediate prompt to the at least one machine learning model.

In some cases, the at least one machine learning model comprises a first model and a second model, wherein the response is generated by the first model, and wherein a second response is generated by the second model.

In some cases, at least one of the plurality of agents, when executed, is configured to retrieve data from an API endpoint.

In some cases, the first agent comprises a first prompt for the at least one machine learning model, and wherein instantiating the first agent comprises: providing the first prompt to the at least one machine learning model for execution; and receiving a first output of the first agent generated by the at least one machine learning model.

In some cases, the second agent comprises a second prompt for the at least one machine learning model, and wherein instantiating the second agent comprises: providing the second prompt to the at least one machine learning model for execution; and receiving the output of the second agent generated by the at least one machine learning model.

In some cases, instantiating the second agent further comprises providing the second prompt and the first output of the first agent to the at least one machine learning model.

In some cases, the first output comprises a data field, further comprising: requesting a user input associated with the data field, and updating the first output based on the user input.

In some cases, the method further comprises instantiating a third agent of the plurality of agents based on the response, the third agent represented by a third node of the plurality of nodes in the hypergraph.

In some cases, the third agent comprises a third prompt for the at least one machine learning model, wherein instantiating the third agent comprises: providing the third prompt to the at least one machine learning model for execution; and receiving a third output of the third agent generated by the at least one machine learning model.

In some cases, instantiating the second agent further comprises providing the third output of the third agent to the at least one machine learning model.

In some cases, the plurality of agents comprises the first agent, the second agent and at least one additional agent, further comprising, for a subset of the at least one additional agent, instantiating each agent of the subset and receiving a respective output.

In some cases, instantiating the respective agent of the subset comprises providing at least one output of the first agent or another agent of the subset that precedes the respective agent in the hypergraph.

In some cases, the first output of the first agent is in a structured format.

In some cases, the structured format is defined in the initiation prompt.

In some cases, the hypergraph is a directed hypergraph.

In some cases, the directed hypergraph is a directed acyclic hypergraph.

In some cases, the first prompt is generated based on a predetermined prompt structure.

In some cases, the method further comprises, prior to or concurrently with providing the initiation prompt, retraining the at least one machine learning model using a database of prior responses.

In some cases, the method further comprises storing the response in the response database and further retraining the at least one machine learning model using the response database.

In another broad aspect, there is provided an apparatus for performing a task using a chain of thought model, the apparatus comprising: a memory; and a processor configured to: provide an initiation prompt for execution by at least one machine learning model, the initiation prompt including an objective and instructions to define a plurality of agents for achieving the objective and an arrangement of the plurality of agents; receive a response to the initiation prompt generated by the at least one machine learning model, the response defining the plurality of agents and the arrangement of the plurality of agents, wherein the arrangement comprises a hypergraph in which a plurality of nodes represents the plurality of agents, respectively, and in which a plurality of edges represents data connections between the plurality of agents; instantiate a first agent based on the response, the first agent represented by a first node of the plurality of nodes in the hypergraph; instantiate a second agent based on response, the second agent represented by a second node of the plurality of nodes in the hypergraph; and obtain an output of the second agent.

In another broad aspect, there is provided a system for performing a task using a chain of thought model, the system comprising: a frontend; a backend; and a machine learning model processor, wherein the backend is configured to provide an initiation prompt for execution by at least one machine learning model, the initiation prompt including an objective and instructions to define a plurality of agents for achieving the objective and an arrangement of the plurality of agents; wherein the machine learning model processor is configured to generate a response to the initiation prompt, and provide the response to the backend; wherein the backend and the machine learning model processor are further configured to instantiate a first agent based on the response, the first agent represented by a first node of the plurality of nodes in the hypergraph, and instantiate a second agent based on response, the second agent represented by a second node of the plurality of nodes in the hypergraph; and wherein the backend is configured to obtain an output of the second agent.

In another aspect, there is provided one or more tangible machine-readable media including logic encoded in the one or more tangible machine-readable media for execution by one or more processors and when executed operable to perform steps comprising: using an artificial intelligence (AI) language model, generating a series of sequential instructions or operations represented as a chain of thought (CoT) model to perform a task, wherein generating the series of sequential instructions or operations comprises: building an initiation prompt specifying that an output is in a particular format readable by a program that executes the instructions building a series of next prompts subsequent to the initiation prompt by selecting in a particular order of stored generic prompts of certain types and/or executing particular application programming interface (API) calls; and feeding the initiation prompt and the series of next prompts into a language model to execute and to create the series of sequential instructions, wherein each input in an instruction or operation includes a next prompt based, at least in part, on selecting one or more preceding outputs of the instructions or operations in the CoT model.

In some cases, the initiation prompt further specifies that the agent outputs are represented in a particular data structure.

In some cases, each agent comprises at least one base property including one or more of an identifier, a name, or a description.

In some cases, the steps further comprise executing the completed series of sequential agents to perform the task.

In some cases, the AI language model includes Generative Pre-trained Transformer 3 (GPT3).

In some cases, each sequential chain of thought output increases in granularity of detail and relates to and of the previous outputs of the series of sequential agents.

In some cases, the steps further comprise receiving user input to modify one or more agents for one or more of the chain of thought outputs.

In some cases, the API call is to an external resource to search for and retrieve information.

In some cases, at least one of the prompts is a choose type in which an item is chosen from a list of items generated in a previous chain of thought output.

In another aspect, there is provided one or more tangible machine-readable media including logic encoded in the one or more tangible machine-readable media for execution by one or more processors and when executed operable to perform steps comprising: generating a series of sequential agents represented as a chain of thought model with an artificial intelligence (AI) language model to perform a task, wherein each agent includes: a description, inputs and outputs, wherein each agent prior to a terminating agent specifies an objective to generate inputs for a subsequent agent; wherein each agent subsequent to an initiation agent is based on a preceding chain of thought output; and wherein the agents are output in a particular format readable by a program that can execute those agents.

In a further aspect, there is provided an initiation CoT meta prompt method in which: step by step instructions for a task are outlined; an algorithm is generated by a large language model and represented as the CoT model as described herein (e.g., in the preceding paragraph), the CoT model including a set of agents to complete the task; and an output is returned in a data format usable for a program to execute and perform a task.

In another broad aspect, there is provided a method for generating a chain of thought content using an artificial intelligence (AI) system, the method comprising: receiving an initiation prompt designed to be input to the AI system; generating subsequent prompts, wherein each subsequent prompt is generated, at least in part, based on a prior output in the chain of thought technique; and submitting at least one of the subsequent prompts to the AI system to generate the chain of thought content.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The disclosure is illustrated by way of example, and not by way of limitation in the figures in which like reference numerals are used to refer to similar elements.

FIG. 1 is a conceptual diagram illustrating an example environment in which various aspects of a CoT meta-prompting system can be implemented, in accordance with some implementations.

FIG. 2 is a flowchart of the CoT meta-prompt process (also referred to as a CoT technique), in accordance with some implementations.

FIGS. 3A and 3B are sequence diagrams an illustrative example of a CoT meta-prompting process, in which FIG. 3A shows a process of building an initiation prompt and requesting a task T, and FIG. 3B shows enhancing data structures and creating sub instructions, in accordance with some implementations.

FIGS. 4A to 4C are sequence diagrams of illustrative examples of various operation types that may be employed in the CoT meta-prompting process, in which FIG. 4A shows a brainstorm and choose operation, FIG. 4B shows a repeat and loop over operation, and FIG. 4C shows operations to use external resources, in accordance with some implementations.

FIGS. 5A to 5E are schematic diagrams of various example pages of a graphical user interface to create a CoT chain via the CoT meta-prompt system, in accordance with some implementations.

FIG. 6 is a schematic diagram of a reiterative process to enhance a CoT chain, in accordance with some implementations.

FIG. 7 is a schematic diagram of an initiation prompt, in accordance with some implementations.

FIG. 8 is a block diagram of an example computing device, which may be used for implementations described herein, in accordance with some implementations.

FIG. 9 is a flow chart diagram of an example method of performing a task using a chain of thought model in accordance with at least some implementations.

### DETAILED DESCRIPTION

A machine learning model can be directed to perform a variety of tasks by inputting a prompt into the machine learning model. The prompt may specify particular parameters for the machine learning model to follow in completing the task. In some instances, the prompt may ask the machine learning model to show results step-by-step in a chain-of-thought (CoT), in which each step to be performed in executing the task is shown as an instruction by the machine learning model.

The described CoT meta-prompting systems and methods enable automatic and recursive generation of a series of sequential “agents” (configured to execute agents) as a chain-of-thought (“CoT”) for a given task using a machine learning model. A CoT meta-prompting system may handle a complex task by breaking the task into manageable and digestible steps, each of which can be individually solved. The outputted CoT chain includes a sequence or arrangement of agents that are linked together. The terms “CoT”, “CoT chain”, “sequence of agents”, “sequence of instructions”, “sequence of operations′, and “series of sequential agents” or variations thereof, may be used interchangeably herein to refer to the CoT output of a machine learning model. Each agent in the CoT chain may take at least one input and produce at least one output. The output of one agent may be used as the input for one or more subsequent agents, which may be input for the direct following agent or may be input for any subsequent agents down the CoT chain. The captured CoT may be automatically executed with a task execution system.

Chain of thought meta-prompting is a process of creating an input prompt for a machine learning model that is based on any previous output(s) in a CoT chain, resulting from another previous prompt. In CoT meta-prompting, the input prompt for a machine learning model generates instructions that are used, at least in part, to generate another subsequent input prompt, and so on. In some implementations, any of a previous output is combined with stored information, such as previously generated prompt templates, to form an input for a next agent. The output of one or more previous agents are incorporated into a next prompt. The term “next” as used herein can refer to a direct subsequent prompt/instruction/input or to any subsequent prompt/instruction/input down the CoT chain. CoT meta-prompting generates a set of instructions to complete a task and produce a target output.

An initiation prompt, also referred to as a “CoT meta-prompt” is built to generate an output in a particular data exchange format, e.g., JavaScript Object Notation (JSON), that can be parsed and saved as the CoT chain. The initiation prompt includes rules, for example, to create a list of instructions for a task, use a CoT model, and return the result in a data exchange format.

The generated CoT can be executed as many times as desired. Each agent can belong to a particular category, for example, large language interactions or web services, such as to call an API and/or conduct a search. There may be generic prompts for each type of agent, such as a brainstorm type. The prompt is built for the specific agent by feeding inputs, desired outputs, a description of the agent's purpose, and in some instances, guidelines for the agent. The CoT meta-prompting process can be also used to break down the CoT chain result. If there are a number of agents agents and some agents are challenging to achieve, a specific CoT can be recursively built for those difficult agents.

The following terms may be referred to in this description:

CoT model (also referred to as a data structure or data model)—A representation of a CoT including any outputted agent in a CoT chain generated using meta-prompts. Examples of CoT data structures include hypergraphs, directed graphs (e.g., directed acyclic graph), tree graphs, linked lists, web graphs, etc. In some implementations, a CoT chain can be represented as a directed acyclic graph that includes nodes representing agents and with edges that represent data dependencies between agents.

Data exchange format—The format in which data is exchanged between agents in a CoT. Some examples of simple formats may include JSON or XML and more complex formats examples may include Protobuf or Avro.

Agent—A module that comprises a set of operations or instructions that produces zero or more outputs when executed, or which produces a change in the internal state of a program when executed. An agent in a CoT takes zero or more inputs and produces zero or more outputs when executed. The inputs and outputs of an operation agent may be connected to inputs and outputs of other agents in a CoT. Some agents may be referred to as instruction agents or operation agents.

Input—Refers to a piece of data that is fed into an agent. An input may have a name (e.g., identifier) and/or a data type.

Output—Refers to a piece of data that is output from an agent. An output may have a name (e.g., identifier) and/or a data type.

The CoT meta—prompting system generates a CoT chain with a single initiation prompt inputted into the machine learning model. The initiation prompt may also be referred to as the CoT meta prompt. Each prompt, including the initiation prompt and except for a terminating prompt described below, used in the CoT meta-prompting process may include one or more CoT rules (also referred to as “parameters” for purposes of this description).

The initiation prompt may include one or more special core rules that specify: (1) the objective is to produce step by step (CoT) instructions to complete a given task, (2) the instructions or operations must be represented using a given CoT model, and/or (3) the output must adhere to a given data exchange format. In some implementations, the core rules include all three of these listed rules: objective to complete a specific task, use of a predefined CoT model. and output in a predefined data exchange format. In some implementations, the core rules include one or two of the listed rules, such as objective to complete the specific task and output in the predefined data exchange format. In some implementation, in addition to the initiation prompt, subsequent prompts may include one or more of the core rules. For example, typically subsequent prompts include the core rule that the output must follow a particular format

In some implementations, the initiation prompt and/or subsequent prompts can include one or more additional CoT rules in order to produce better output results, e.g., for the output to be more predictable. Such additional rules may include one or more of the following: (1) each agent has a set of base properties (e.g., identifier, name, description), (2) each agent has a list of operations, (3) each agent has a list of inputs and a list of outputs. (4) each agent input and output has a name and a type, (5) restrict the inputs and outputs to particular types (e.g., String, Boolean, Number, Object, Array, etc.).

In some implementations, the building of the CoT chain includes determining a series of sequential generic prompts according to an input initiation prompt. The generic prompts may be retrieved from prompt templates in a storage, e.g., a database. The generic prompts are selected and ordered to build the CoT chain. The series of generic prompts may be fed to the machine learning model with a request to complete the CoT by completing the dynamic descriptions with information that satisfies the initiation prompt. An example of a generic prompt may include:
CONTEXT: <<GOAL>>
   RULES:
      JSON keys must be enclosed in double quotes.
      The output must follow this conventional valid JSON format
   DESIRED OUTPUT:
   <<DESIRED OUTPUT>>
   <<TASK INPUT>>
   <<TASK_GUIDELINES>>
   TASK: <<TASK>>
   Question: Complete the TASK using TASK_GUIDELINES. You must respect the RULES.
   ANSWER:

In this example generic prompt, “<< >>” denotes a dynamic that can be filled in for a particular CoT. For example, <<GOAL>> may be “Brainstorm ideas for a novel”. The <<TASK INPUT>> may be replaced with one or more prior outputs somewhere up the CoT chain. Each generic prompt may include particular rules specific for that type of prompt.

Another example of an initiation prompt may be as follows:
<TASK_GUIDELINES>
<TASK_CONTEXT>
JSON hyper-Schema for an Operation:
{“title”: “Operation”, “type”: “object”, “properties”: {“id”: {“type”: “string”}, “type”: {“type”: “'s tring”}, “description”: {“type”: “string”}, “difficulty”: {“type”: “integer”, “minimum”: 1, “maxi mum”: 5}, “guidelines”: {“type”: “string”}, “inputs”: {“type”: “array”, “items”: {“type”: “string”}}, “outputs”: {“type”: “array”, “items”: {“type”: “object”, “properties”: {“name”: {“type”: “stri ng”}, “type”: {“type”: “string”}}, “required”: [“name”, “type”]}}, “operations”: {“type”: “array “,” items “: {” $ref “:” #“}}},” required “: [” id “,” type “, “description”, “difficulty”, “guidelines”, “i nputs”, “outputs”]}
RULES:
1. Operation Structure:
   Represent the operations as a directed acyclic graph.
   Each operation MUST have an ID, a type, a description, a difficulty (rated 1 to 5), guidelines, inputs, and outputs. The ID should be unique for each operation, the type should indicate the nature of the operation, the description should provide a brief overview of the operation, the difficulty level should indicate the complexity of the operation, the guidelines should provide instructions on how to perform the operation, the inputs should indicate the required data for the operation, and the outputs should indicate the result of the operation.
   For complex tasks (difficulty level greater than 2), operations can have an array of sub-operations. This allows for the breakdown of complex tasks into smaller, more manageable tasks.
2. Operation Types and Properties:
   Each operation type MUST ONLY be one of the following:
<OPERATIONS>
   Special Properties of operations:
<PROPERTIES>
3. Input/Output Requirements:
   All inputs must be a string, referring to the name of the input.
   All outputs MUST have a name and a type. The type MUST be a single value from: [Array<X>, Object<X>, String, Number, Boolean] where X is a single custom object. Examples of custom objects types could be one of the following: <TASK_CONCEPTS>
   All I/O names chosen by you MUST follow snake casing standards.
   Any operation inputs MUST have been provided as output from a previous operation.
   Operation outputs MUST contain a single element.
4. Simplicity and Clarity:
   Encourage simplicity by promoting the use of straightforward language, concise descriptions, and clear guidelines. Break down complex tasks into smaller, more manageable operations that can be easily understood and executed.
5. Final Output and Formatting:
   The last operation MUST always output the desired output.
   You MUST provide the output in Minified JSON, a compressed version of JSON that has been stripped of unnecessary characters.
   You MUST provide one Minified JSON wrapped with <json>tags.
<TASK_DESIRED_OUTPUT>
<TASK>
TODO: Write step-by-step operations on how to complete the TASK to produce the desired output.
HINT: Always start your answer with “<SNIPPET>

A more verbose initiation prompt may be as follows:
<TASK_GUIDELINES>
<TASK_CONTEXT>
JSON hyper-Schema for an Operation:
{” title “:” Operation “,” type “:” object “,” properties “: {“id”: {“type”: “string”}, “type”: {“type”: “'s tring”}, “description”: {“type”: “string”}, “difficulty”: {“type”: “integer”, “minimum”: 1, “maxi mum”: 5}, “guidelines”: {“type”: “string”}, “inputs”: {“type”: “array”, “items”: {“type”: “string”}}, “outputs”: {“type”: “array”, “items”: {“type”: “object”, “properties”: {“name”: {“type”: “stri ng”}, “type”: {“type”: “string”}}, “required”: [“name”, “type”]}}, “operations”: {“type”: “array ‘,” items “: {“$ref”: “#”}}}, “required”: [“id”, “type”, “description”, “difficulty”, “guidelines”, “i nputs”, “outputs”]}
RULES:
1. Operation Structure:
   Represent the operations as a directed acyclic graph.
   Each operation MUST have an ID, a type, a description, a difficulty (rated 1 to 5), guidelines, inputs, and outputs. The ID should be unique for each operation, the type should indicate the nature of the operation, the description should provide a brief overview of the operation, the difficulty level should indicate the complexity of the operation, the guidelines should provide instructions on how to perform the operation, the inputs should indicate the required data for the operation, and the outputs should indicate the result of the operation.
   For complex tasks (difficulty level greater than 2), operations can have an array of sub-operations. This allows for the breakdown of complex tasks into smaller, more manageable tasks.
2. Operation Types and Properties:
   Each operation type MUST only be one of the following:
      brainstorm: Generate ideas or concepts related to the task.
      list: Create a list of items or steps relevant to the task.
      q&a: Formulate and provide answers to specific questions within the same operation to clarify certain aspects or delve deeper into the topic related to the task.
      web_search: Execute a web search.
      wiki_search: Execute a Wikipedia search.
      write: Compose text or content related to the task.
      choose_one_from: Select a single item from a list of options.
      choose_many_from: Select multiple items from a list of options.
      loop_over: Iterate through a list or collection, performing an operation for each item.
      summarize: Provide a concise summary of the given information.
      repeat_n_times: Perform a specific operation a set number of times.
   Special Properties of operations:
      choose_one_from: selection_criteria
      choose_many_from: selection_criteria
      loop_over: collection (Name of the input array that the operation will iterate over)
      repeat_n_times: count (Number of times the specific operation needs to be repeated)
3. Input/Output Requirements:
   All inputs must be a string, referring to the name of the input.
   All outputs MUST have a name and a type.
   Outputs type MUST be a single value from: [Array<X>, Object<X>, String, Number, Boolean] where X is a single custom object. Examples of custom objects types could be one of the following: <TASK_CONCEPTS>
   Always prioritize the use of Object types over String where appropriate for output types.
   All I/O names chosen by you MUST follow snake casing standards.
   Any operation inputs MUST have been provided as output from a previous operation.
   Operation outputs MUST contain a single element.
4. Simplicity and Clarity:
   Encourage simplicity by promoting the use of straightforward language, concise descriptions, and clear guidelines. Break down complex tasks into smaller, more manageable operations that can be easily understood and executed.
5. Final Output and Formatting:
   The last operation MUST always output the desired output.
   You MUST provide the output in Minified JSON, a compressed version of JSON that has been stripped of unnecessary characters.
   You MUST provide one Minified JSON wrapped with <json>tags.
<TASK_DESIRED_OUTPUT>
<TASK>
TODO: Write step-by-step operations on how to complete the TASK to produce the desired output.
HINT: Always start your answer with “<SNIPPET>

Another example of a generic object properties includes:
RULES:
   Each property has a name and a type. The type must be one of these three values: [Array, Object, String, Number].
   If you forget commas between objects, or properties/values your code will break.
   Format everything correctly so it adheres to the minified JSON structure.
CONTEXT: <<CONTEXT>>
TASK: <<TASK>>
TODO: List what are the properties of the <<DESIRED_OUTPUT>>. You must follow the RULES.
ANSWER:

The operations can each have an operation type. Examples of operation types may include brainstorm, choose, repeat, loop, write, search, if_then_else, etc. Various families of operations may also be employed, such as operations meant to execute with the machine learning model, e.g., LLM, and operations that require custom features.

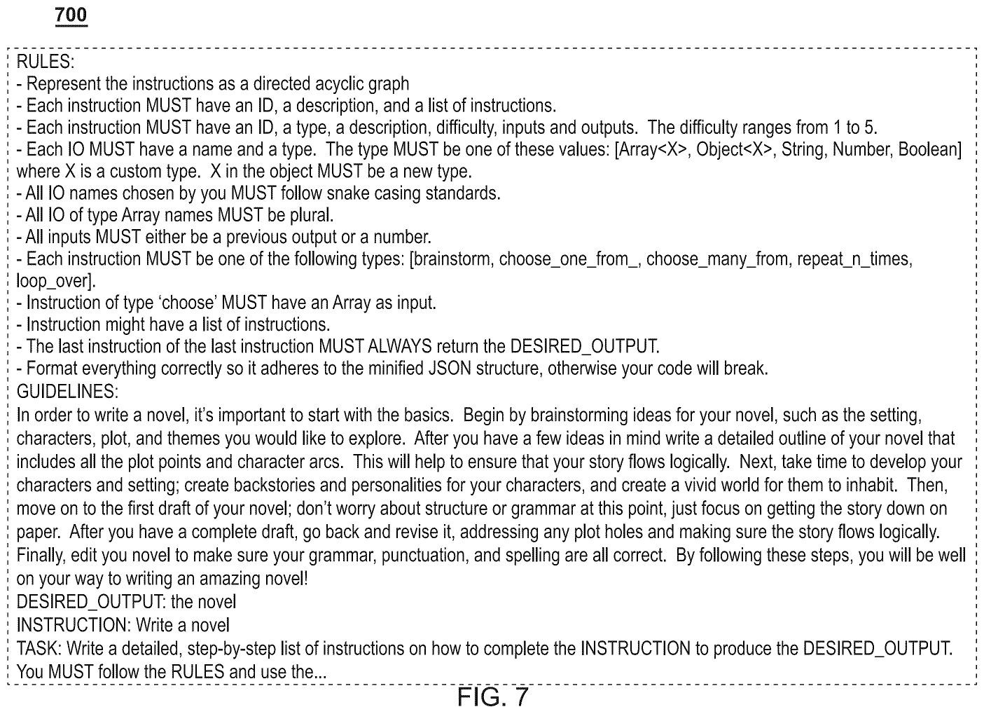

An initiation prompt may specify requirements and suggestions to generate: a list of sequential agents, or a mix of agents in the CoT chain. In some implementations, an agent defines an input and output of an instruction block. An example of an initiation prompt 700 is shown in FIG. 7. The initiation prompt 700 includes a set of rules, guidelines, desired output, core instruction description, and a task.

There are numerous applications for tasks that may be performed by the CoT meta-prompting system, including but not limited to:

### Entertainment Field

Dialogue generation for movies or video games.
Story generation
Character design
Plot generation
Song generation
Joke generation

### Education Areas

Learning content generation
Question generation
Test generation
Lesson planning
Curriculum design

### Marketing Field

Advertisement generation
Campaign planning
Slogan generation
Product names
Landing page generation

### Sales Field

Sales scripts
Sales presentations
Proposal generation

### Support

Chatbots
Virtual assistants
Customer support
Technical support

Other applications and fields/areas of use are possible.

In the following, a method, an apparatus and a system for performing a task using a chain of though model are described. The exemplary apparatus includes a memory and a processor. The memory and processor are configured to provide an initiation prompt for execution by at least one machine learning model. The initiation prompt includes an objective and instructions to define a plurality of agents for achieving the objective and an arrangement of the plurality of agents. The memory and processor are configured to receive a response to the initiation prompt generated by the at least one machine learning model. The response defines the plurality of agents and the arrangement of the plurality of agents. The arrangement comprises a hypergraph in which a plurality of nodes represents the plurality of agents, respectively, and in which a plurality of edges represents data connections between the plurality of agents. The memory and processor are configured to instantiate a first agent based on the response, the first agent represented by a first node of the plurality of nodes in the hypergraph, instantiate a second agent based on response, the second agent represented by a second node of the plurality of nodes in the hypergraph, and obtain an output of the second agent.

The exemplary system includes a frontend, a backend, and a machine learning model, each of which may be executed by at least one processor. The backend is configured to provide an initiation prompt for execution by at least one machine learning model. The initiation prompt including an objective and instructions to define a plurality of agents for achieving the objective and an arrangement of the plurality of agents. The machine learning model processor is configured to generate a response to the initiation prompt, and provide the response to the backend. The backend and the machine learning model are further configured to instantiate a first agent based on the response, the first agent represented by a first node of the plurality of nodes in the hypergraph, and instantiate a second agent based on response, the second agent represented by a second node of the plurality of nodes in the hypergraph. The backend is configured to obtain an output of the second agent.

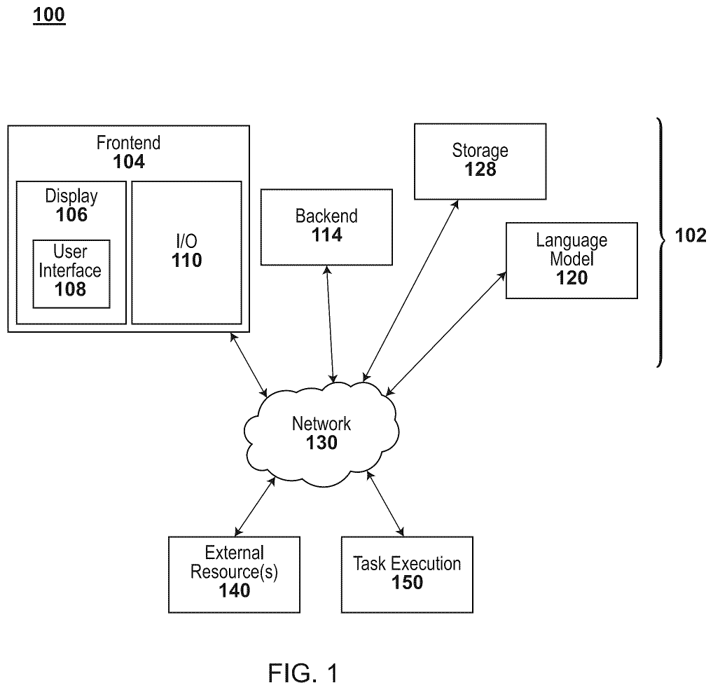

FIG. 1 shows an example environment 100 in which various aspects of the CoT meta-prompting system can be implemented having components that may be connected via network 130. In some implementations, two or more components of the environment 100 may be integrated within a same device. The CoT meta-prompting system 102 includes a frontend device 104 to enable a user to interact with a backend device 114. The backend 114 interfaces with one or more machine learning model 120, such as a large language model (LLM). A storage unit 128, such as a database, receives, stores and returns data and information. In some implementations, one or more external sources 140 may be accessed to provide additional services and information. A task execution system 150 may receive and execute a completed and finalized CoT generated by the CoT meta-prompting system.

The frontend 104 may include a computing device configured for a user to interact with the backend 114 through an input/output interface 110. The frontend 104 includes a display 106 configured to display a graphical user interface 108 for the user to view various information and input information associated with the CoT meta-prompt process.

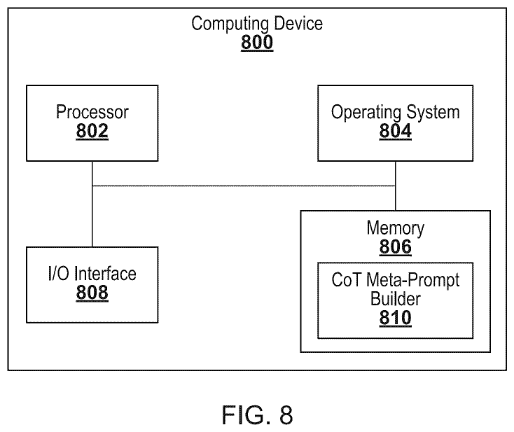

The backend 114 may include a computing device, as described below with regards to FIG. 8. The backend includes one or more modules to build meta-prompts for the machine learning model to use, convert text entered by a user in the frontend to a format and structure readable by the machine learning model 120. For example, to build an initiation prompt, the backend receives text inputted from the user to the frontend, extracts important information from the text to include in the initiation prompt, and builds the prompt into a data structure and format readable by the machine learning model.

The machine learning model 120 is an artificial intelligence (AI) model that is configured to create the CoT for a given task. The machine learning model may be a large language model (LLM) that can perform complex reasoning, such as Generative Pre-trained Transformer (GPT-3, GPT-4, GPT-4-Turbo, etc.) large language model, or other language models that may be developed appropriate to create a CoT according to the CoT meta-prompt process described herein.

The storage 128 may include a database or other storage unit to store data for the CoT, including parsed agents of the CoT.

In some implementations, a prompt built by the backend 114 may include a command to create an API call to the external resource 140, such as to search for and/or retrieve information.

The virtual production system in FIG. 1 is a representation of various computing resources that can be used to perform the process actions and steps described herein. Any number and type of discrete or integrated hardware and software components may be used. The components may be located local to, or remote from the other system components, for example, interlinked by one or more networks.

Building on top of the CoT meta-prompting technique, task performance system, “Framework for Automated Task Execution” with use of LLM's (referred to as “FATE”) provides a framework that allows automatic capture of a CoT for a given task, and automatically executes the captured CoT with a backend system, which may be the same or different from backend 114 of the CoT meta-prompting system.

FATE may consist of two main components: A FATE Generator (such as the frontend, backend and machine learning model as described above with regard to FIG. 1) that takes as input a natural language description of a task and produces as output a chain-of-thought using CoT meta-prompting (CoTMP). The CoTMP can be used recursively to break down the agents of the generated chain-of-thought into more manageable operations. The Generator can also offer a friendly UI, for assisted CoT generation. The generator also defines the configuration of the CoTMP (ex: operation types, data types, etc.).

Another component of FATE includes a FATE Executor (such as task execution system 150 of FIG. 1), including an engine that takes as input a CoT chain created by the CoT meta-prompt process and executes it, step by step, by calling appropriate backend services. Such backend services can be any kind of service that can be called from a computer program, such as web services, databases, or file systems, but it can also be a specific call to the LLM using some engineered prompt. The engine can handle all operation types produced by the generator.

FATE may be designed to be easily extensible. New configurations can be added to the CoTMP. New types of operations can also be added to the FATE Generator component by engineering new types of prompts. New backend services can be added to the FATE execution engine to handle new operation types.

In some implementations, the particular machine learning model used, such as GPT, may be finely tuned with feedback for retraining with the present CoT meta-prompting system. The CoT builder may be used to create CoTs for many tasks. Examples of CoT's, such as two hundred examples of CoT's, may be stored and fed back to the machine learning model for retraining. A fine-tuned model may be created with a stored CoT dataset. The training may include providing a ‘prompt’ and a ‘completion’.

In employing a GPT machine learning model, the format of the CoT dataset may be similar to the format provided by GPT when using the CoT meta prompt, such as JSON format. For example, a prompt that recites, “Create instruction for the task X” may result in a JSON output representing the CoT. The updated model may be used to output an improved prompt for creating further CoT chains for a specific task. The fine-tuned machine learning model could provide better CoT JSON when prompted, e.g., with “Create instruction” as the task definition. The machine learning model can be repeatedly fine-tuned with new tasks with added operation type handlers on the backend.

The present CoT meta-prompting system facilitates automated task execution using machine learning models and encompasses many benefits over current systems. For example, the CoT meta-prompting system is not restricted to output of agent being the input of the direct next agent, but instead allows an output of any previous agent to be used as input at any agent. In addition, the CoT meta-prompting system introduces the use of data-exchange format which allows for LLMs to have a consistent and reliable function signature, eliminating a risk of unintentional output type changes breaking chains. Furthermore, the CoT meta-prompting system allows users to bypass the need to pre-create prompts, as the Chain-of-thought meta prompt outputs agents of the desired types. Each agent type may use a generic prompt for that specific agent, drastically reducing the amount of time users need to invest in the design of a CoT chain. In addition, the CoT meta-prompting system provides the CoT meta-prompt, which allows users to quickly break a task down into smaller subtasks and create a chain from those, making it easier for users to decompose a node into more nodes as the CoT meta-prompt will handle the prompting for the user.

Some benefits may include:
1: flexibility of node to node connection (not strictly linear),
2: the machine learning model generates the CoT chain,
3: strict dynamic typing provides for standardized interaction between nodes,
4: standardization of node to node communication provides robustness,
5: standardized operation types in the CoT substantially reduce the need for user input, and
6: FATE's node decomposition into subtasks automates node generation.

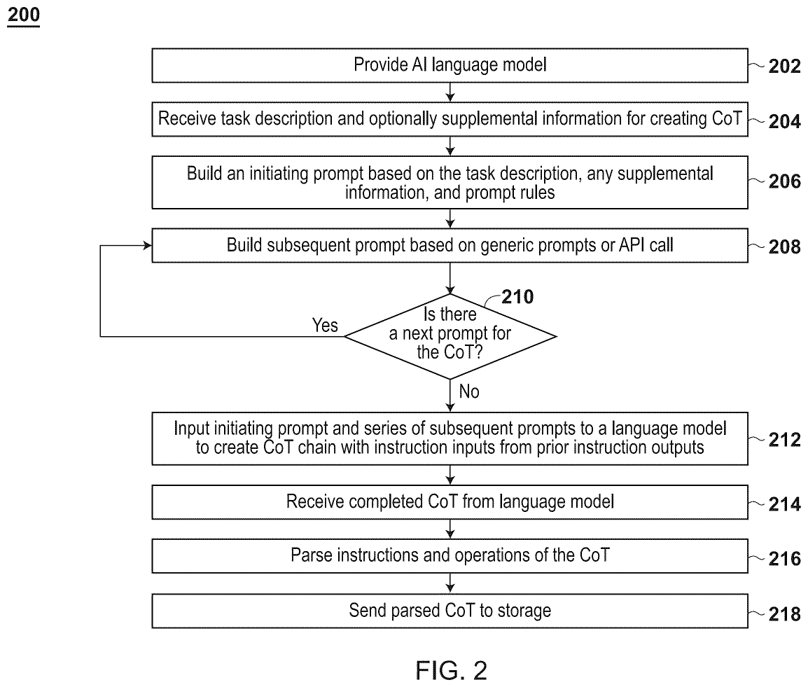

FIG. 2 shows a flow chart of a CoT meta-prompt process 200 in which sequential instructions are generated to perform a task, such as the processes performed by the backend 114 in FIG. 1.

In block 202, access to a language prediction model, such as an AI large language model is provided. In some implementations, an autoregressive LLM using deep learning, such as GPT-3 or an LLM with comparable or greater capacity is used.

In block 204, a task description is received, such as from the frontend entered by the user, for creating the CoT. In some implementations, an output description, and/or supplemental information, such as guidelines and context, may also be received.

In block 206, an initiating prompt is built, based on the received task description, any supplemental information, and prompt rules. The initiating prompt is built to include the required prompt rules, such as core rules, as described herein.

In block 208, a subsequent (next) prompt is built by selecting a particular type, e.g., brainstorm, of a stored generic prompt and/or by calling an application programming interface (API) to an external source, such as conducting a search for information to be used in the next prompt.

In decision block 210, it is determined if there is a next prompt in the order needed for the CoT chain. If there is a next prompt to be added for the CoT chain, the process returns to block 208 to build the next subsequent prompt of a particular type and/or API call. If there are no further prompts in block 210, the last prompt to be built for the CoT chain is considered a terminating prompt. The process proceeds to block 212.

In block 212, the initiating prompt and the series of ordered next prompt(s) are fed into the machine learning model to form the basis of each instruction and generate the series of agents of the CoT chain. Dynamic fields in each generic next prompt in the series of prompts are replaced with data specific to the task as outlined in the initiating prompt, including rules for each prompt/instruction/operation. Task input dynamic fields are filled in with outputs from one or more preceding instructions/operations, with the exception of the first prompt of the series of prompts that may not include such an input.

Rules may include one or more of, an objective to generate a next instruction to perform the task, the next instruction generated is represented using a data structure (such as an acyclic graph), and the next chain of thought output adheres to a data exchange format. A terminating prompt may or may not include one or more of the core prompt rules. In some implementations, the prompt rules include a qualification that the rules only apply if there is a next instruction in the CoT chain. A terminating prompt/instruction/operation may have limited or no rules, such as no rule to create a next instruction or operation.

The terminating instruction or operation may be identified if all requirements of the task information entered by the user are fulfilled, such as requirements in the task description, target output, context, and guidelines. The terminating instruction or operation may also be identified if a level of difficulty has been reached by the growing CoT chain.

In some implementations, a predefined level of difficulty may be associated with creating a particular CoT. The level of difficulty may be a numerical indication within a scale (such as a level 3 out of a scale of 5, where the higher the number the more steps required), descriptive words, or symbols. In some implementations, the level of difficulty may specify the number of steps or the range of steps to be in the CoT, such as 10 instruction steps, or 10 to 15 instruction steps. In some implementations, the level of difficulty may specify a length of the CoT, such as a number or a range of numbers of instruction steps to be created in the CoT chain by the machine learning model.

The level of difficulty may be entered by the user, for example with the task information used in the initiation prompt. In some cases, the level of difficulty is provided automatically by default. In still some implementations, the level of difficulty may be determined by the CoT meta-prompting system based on various factors, such as a type of task, or based on the task description, context, requested output, guidelines, etc.

In some implementations, the agents may be associated with at least one base property including one or more of an identifier, a name, or a description. The base property may be used to identify the instruction, for example to request enhancement of the instruction, as described below, or to include the instruction in a subsequent prompt.

In block 214, the series of sequential instructions of the resulting CoT chain is received from the machine learning model. The resulting CoT chain may be provided to a user via the frontend, to a task performance unit to execute the task according to the series of instructions, and/or to a storage unit. In some implementations, the user views the completed CoT and accepts or rejects the completed CoT. If the sequence of instructions are accepted, the user may activate performance of the task, such as by a task performance unit.

In block 216, agents of the CoT may be parsed in some implementations. In situations where the CoT chain is parsed, the parsed CoT may be sent to storage, in block 218.

Although the steps in FIG. 2 may be presented in a specific order, this order may be changed in different particular implementations. In some particular implementations, multiple steps shown as sequential in this specification can be performed at the same time. Furthermore, additional steps may be included in the method or left out of the process, such as the parsing steps in blocks 216 and 218 may be not employed in a CoT meta-prompt process or may be performed after each instruction is generated or before the completed CoT chain result is provided to the user.

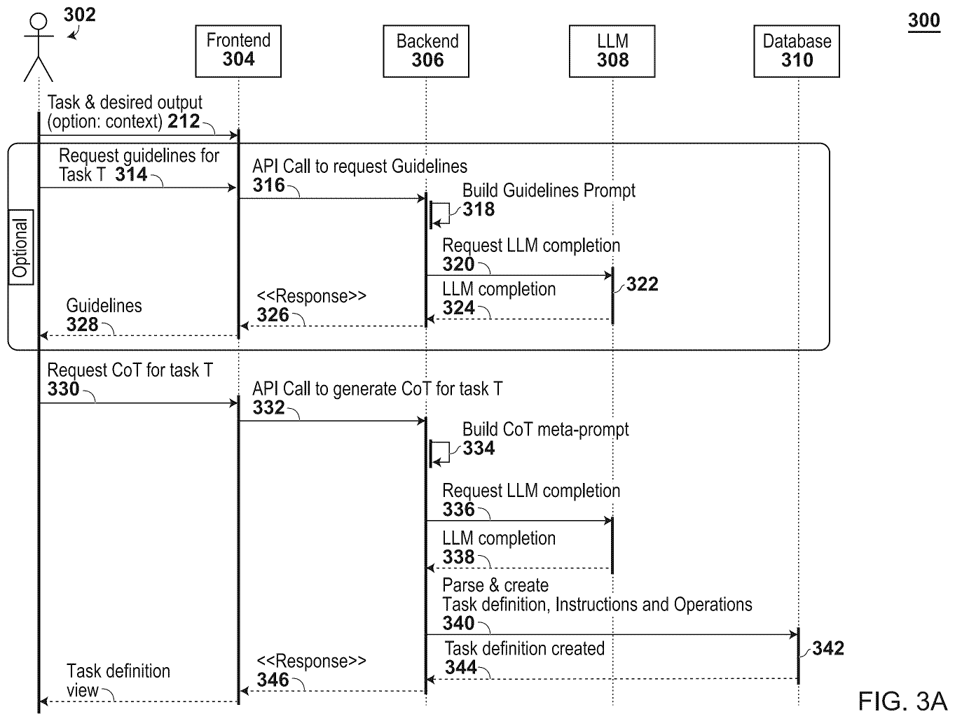

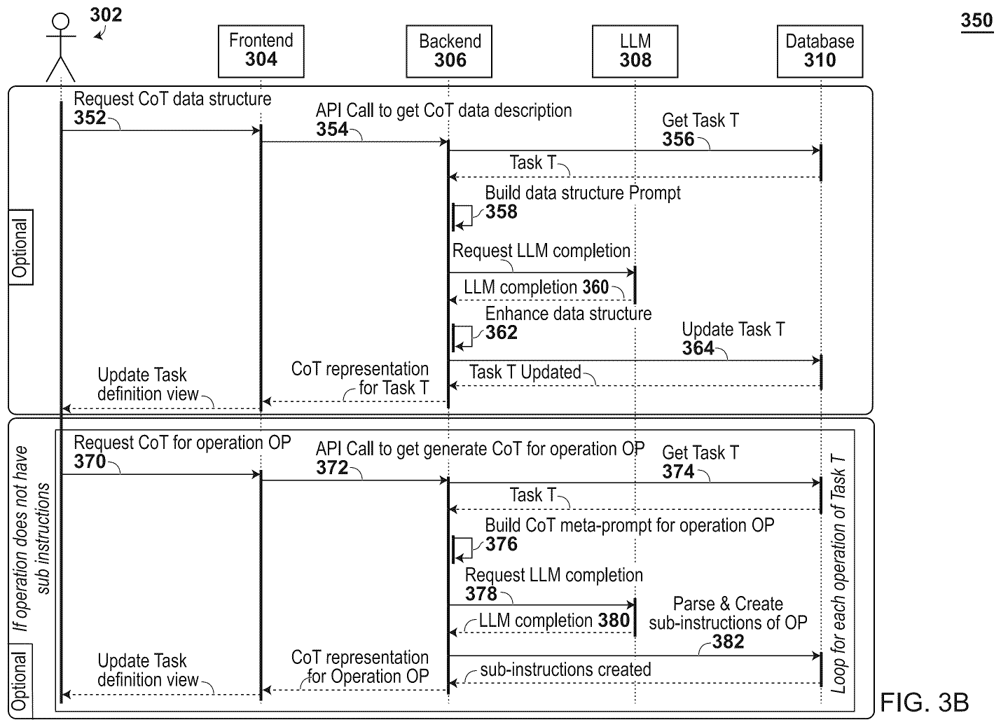

FIG. 3A shows an illustrative example of a CoT meta-prompt process 400 initiated by a user 202 interfacing with a frontend 304 (e.g., in FIG. 1), such as a user device, which communicates with backend 306 (e.g., 114 in FIG. 1). The backend 406 interacts with one or more machine learning models 308 (e.g., 120 in FIG. 1), and may also interact with a database 310 (e.g., 128 in FIG. 1), to retrieve and store data. Other types of storage may be used.

The user 302 initiates the CoT meta-prompt process 300 by entering 312 a CoT initiation request that includes a task description indicating a target output. In various implementations, a task description may be entered by a separate software algorithm and/or device.

In some implementations, the task description may be accompanied by supplemental information, such as target output, context information, and guidelines, to add to directions provided by the task description for the machine learning model. Such supplemental information enables an output result that aligns closer with a target result of the user. For example, context information may be entered by the user 402 to provide considerations for the CoT meta-prompting process. Context information may include, for example, background information, particulars to be included in the task, reasons or applications for the task, a user perspective on the task, a setting and/or scope, etc.

In some implementations, the user 302 may enter task guidelines to be followed in performing the CoT meta-prompt process for the task (e.g., task T). The guidelines typically include a requirement for the machine learning model to create step-by-step instructions for the given task, hence producing the requested CoT chain. Task guidelines may include user preferences for the resulting output and/or a framework from which the process is performed. Some guidelines may include one or more example outputs to be used by the CoT meta-prompt system as a basis for the CoT meta-prompt, e.g., the output result needs to be similar to the guidelines example or similar to a particular aspect of the example, the output result needs to be dislike the guidelines example, etc. To illustrate example guidelines, a task to create a novel may be associated with a task guideline for the resulting novel to be reminiscent of a novel by Charles Dickens. Guidelines may also include a rough sketch of the output result that the user targets.

At times the guidelines may provide strict rules that are required to be followed by the process, such as, the CoT must include particular step(s). Guidelines may describe broad concepts of what is to be achieved by the task and how the CoT may achieve such results. Guidelines may also include mere recommendations of steps that may be followed in generating the CoT. Other types of guidelines are possible. In other implementations of the CoT meta-prompt process, no guidelines are associated with the task.

In some implementations, the user 302 may employ the CoT meta-prompt system to generate 314 task guidelines for the Task T. In these cases, the frontend 304 may make an application programming interface (API) call 316 to the backend 306 for one or more task guidelines to be generated. The backend 306 builds a prompt directing the machine learning model 308 to generate 318 the guidelines. The backend 306 calls 320 to the machine learning model 308 to create the guidelines (request LLM completion) that may be inputted back into the machine learning model to complete the request to generate task guidelines. The machine learning model returns 322 completed guidelines to the backend 306, and the backend 306 may return the guidelines 326 to the frontend 304.

In some implementations, returned guidelines created by the backend 306 and machine learning model 308 are suggested guidelines returned 328 to the frontend 304 for the user to review and determine whether to accept the suggested guidelines, use alternative guidelines (for example created by the user or other source), use one or more portions of the returned guidelines, revise the request for guidelines to the backend 306 (such as with more specific requirements for the guidelines), or opt to not use any guidelines with the task description in the initiation prompt. In still some implementations, the completed guidelines remain at the backend to automatically associate with the incoming task request without the need to provide the guidelines to the frontend 304 for user review or user interaction.

The request for the CoT for Task T is entered 330 as a CoT initiation request along with any supplemental information for the CoT meta-prompt process to complete the CoT for the task. The CoT initiation request is received by the frontend 306, which sends a call 332 for the CoT to the backend 306. The backend builds 334 a CoT meta-prompt (also known as an initiation prompt) with the initiation information provided by the user via the frontend 304. The CoT meta-prompt includes rules, such as prompt rules described above, for the machine learning model to complete the CoT. The built CoT meta-prompt is inputted 336 to the machine learning model 308.

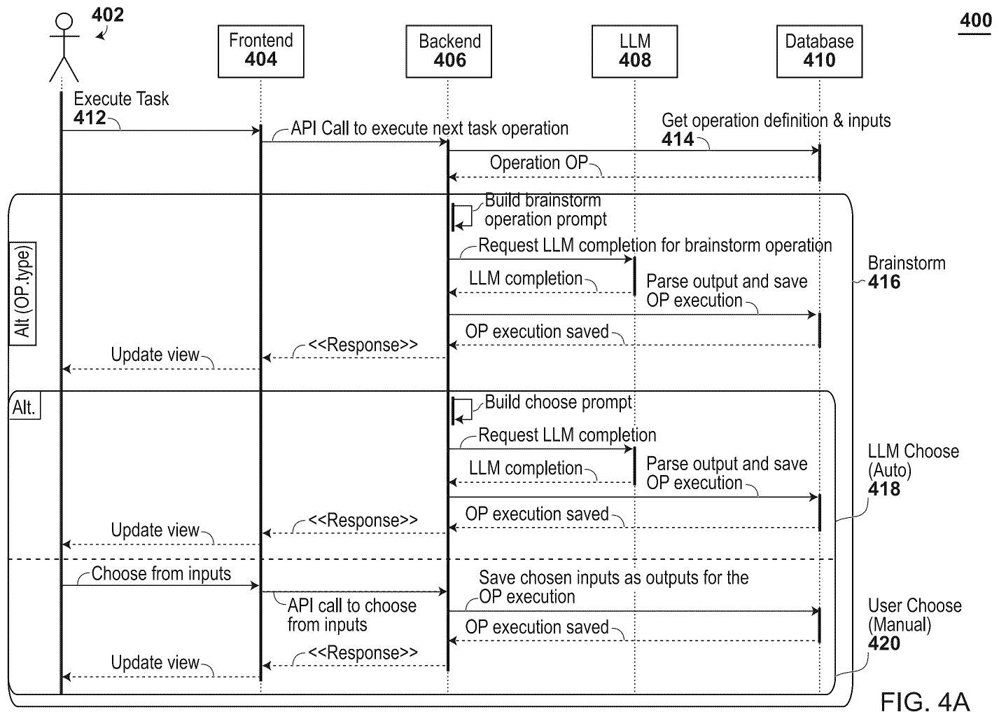

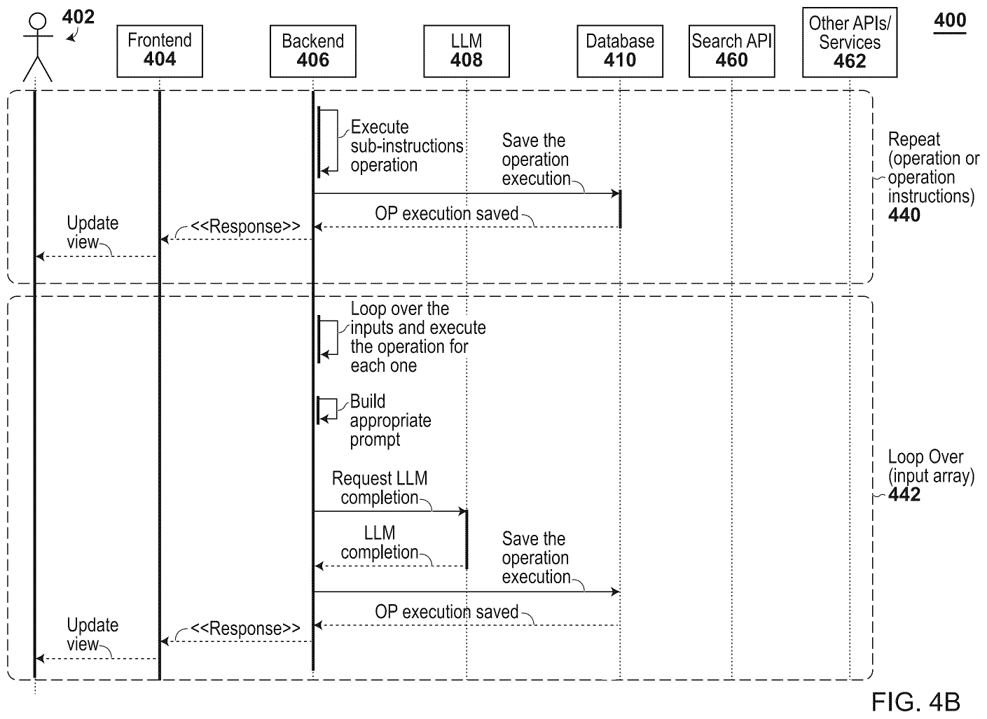

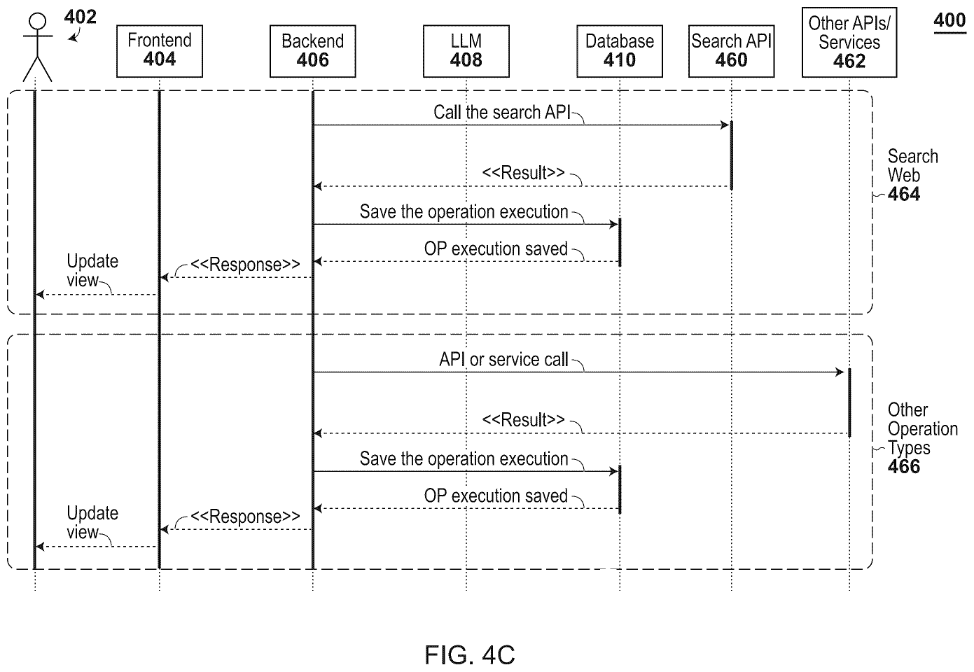

The machine learning model 308 uses the CoT meta-prompt to generate 338 a completed CoT. The machine learning model generates the CoT via meta-prompting according to the process described with regard to FIG. 4 and described below. The machine learning model returns the completed CoT to the backend 306. At times, the completed CoT is automatically employed to perform the task that is the subject of the CoT.

In some implementations, the backend 306 provides the completed CoT created via the CoT meta-prompt process to the database 310 for storage. The created CoT may be parsed by the backend and stored as parsed components of the CoT, such as definitions, data structures, and agents in the completed CoT 340. Storing the parsed components enables a user to further modify individual or groups of components of the CoT, as described below with regards to FIG. 3B.

In some implementations, the completed CoT is provided back to the frontend 304 for the user 302 to view. The user may opt to make revisions to the CoT, such as enhancing data structures and/or agents. The completed CoT, also referred to as a task definition, that is created is returned 344 to the backend 306 provided as a response 346 to the frontend 304, for viewing 346 by user 302. The frontend 304 may provide the task definition on a display for viewing by the user 302.

In some implementations, as shown in FIG. 3B, the CoT meta-prompt process may further include various enhancement processes 350 to produce more granular output results. For example, a user reviewing a completed task definition, as in 346 of FIG. 3A, may seek expansion on a data structure and/or operation in any of the CoT steps in the task definition. An updated task definition may be generated according to the requests.

An optional data structure request 352 may be made by the user 302 via the frontend 304, which, in response, makes an API call 354 to get an enhanced CoT data structure description. The backend 306 may retrieve the CoT for task T 356 from storage in database 310. Upon receiving the CoT for task T from storage, the backend builds a data structure prompt 358 that may be fed as a request to the machine learning model to complete the request 360 by providing additional details of data structures. The backend 306 may use the data structure details to enhance 362 the data structures associated with the original CoT for task T and send 364 the updated task T to the database 310 for storage. The updated task T may be provided from the database to the front end, via the backend for the user to view.

In some implementations, a loop may be executed for each agent or for select agents of original CoT of the task T. If an agent does not have a sub instruction, the enhancement process may create sub instructions to include more details in the CoT. An agent or operations enhancement request 370 may be made by user 302 via the frontend 304 end, which, in response, makes an API call 372 to generate CoT for a particular agent (in this case, agent OP).

The backend 306 may retrieve the CoT for task T 274 from storage in database 310. Upon receiving the CoT for task T from storage, the backend builds a CoT meta-prompt for agent OP 376 that may be fed as a request to the machine learning model to complete the request 378 for additional details for the agent OP. The machine learning model creates sub instructions for the agent OP and returns 380 the completion to the backend. The sub-instructions may be parsed 382 and integrated with the CoT by the backend. The backend may send the parsed and created sub-instructions of the agent OP to the database for storage.

The stored CoT with sub-instructions can be retrieved from the database and viewed by the user as an updated task definition. In some implementations, the process 370 may repeat for additional operations in the CoT of task T.

FIGS. 4A to 4C show sequence diagrams for a CoT meta-prompt process in a user view mode in which actions of the agent in the CoT are viewed by the user prior to execution of each step. In such implementations, the user may have control of development of each step of the CoT. As each instruction is created, the agent with its actions may be provided to the user at the frontend as an updated view. The agents may be displayed to the frontend for the user to view and make modifications to or otherwise interact with the specific actions, if desired. A CoT instruction may include various types of actions, such as brainstorm, choose, repeat, loop over, search, and other services. Other actions are possible.

For illustration purposes, FIGS. 4A-4C show an example of executing a CoT meta-prompt with particular types of actions that are individually viewed by a user as each action of the CoT is executed. Instructions generated by the CoT meta-prompt process may include numerous types of actions that may be executed in various orders.

In some implementations, building of a CoT meta-prompt may be executed by the system in an automatic mode without user interaction. The automatic mode may include automatic enhancements where the CoT meta-prompting system generates sub-instructions for any given instruction without requiring specific requests by user or user interaction. In such instances, the CoT meta-prompting system may determine if an instruction needs to be broken down into sub-instruction based on various factors, such as an assigned level of difficulty. If sub-instructions are required, the system recurses to break the instruction into sub-instructions to provide greater granularity.

In some implementations, the CoT meta-prompting system may be configured to create multiple different CoT chains in response to the initiation prompt. Each of the completed CoT for a given task may be compared by the CoT meta-prompting system or by a user. A select CoT chain may be chosen by the system or by the user to be used in executing the task. Choosing of the CoT chain may be based on which one best satisfies the initiating prompt and task information provided by the user.

In still other implementations, the CoT meta-prompt process may also be performed in a select mode in which particular actions, such as a “choose type” action, may be provided to the user to interact with the step (e.g., user selects an action), whereas other actions, such as brainstorm, may be performed automatically by the system without user interaction.

FIG. 4A shows a user requesting 412 execution of a resulting CoT generated by the CoT meta-prompt process, as described above with regards to FIGS. 3A and 3B. Where the database includes stored CoT operations for the task, the stored components may be accessed 414 by the backend. The stored components may be used the series of agents provided in the completed CoT chain.

The agent of the CoT chain may include one or more brainstorm type actions s 416 step. The backend builds a next step prompt, in this case a brainstorm agent, based on the stored components and inputs a next prompt to the machine learning model. In response to the prompt, the machine learning model determines that a brainstorm agent is a next agent in the CoT and the machine learning model completes the creating of the brainstorm agent. The instruction including the brainstorm agent is returned to the backend, which parses the agent and saves the agent in the database. The brainstorm agent is outputted by the machine learning model in a format and data structure readable by the machine learning model as a next step prompt. The brainstorm agent may be provided from the database to the user via the backend and frontend as an updated view of the CoT. In some implementations, the user may make modifications to the outputted instructions and enter responses to the backend.

In some implementations, an automatic choose agent 418 is created as a next agent in the CoT. The brainstorm instruction may be fed as a next step prompt from the backend to the machine learning model, for the machine learning model to use in creating a subsequent agent for the CoT. The backend builds the next step prompt (choose prompt) based on the brainstorm agent previously outputted by the machine learning model. The backend may build a next step prompt based on one or more of any previously outputted instructions from the machine learning model in the growing CoT.

The machine learning model determines that the next agent requires automatic choosing of the items listed in the brainstorm output. The automatic choosing of instruction may include considering various rules required or suggested to be used in executing the task and choosing an item. Such choosing parameters may be based on the initiation prompt including the task description, context information, guidelines, core prompt rules, additional rules, etc.

In some implementations, manual choose 420 is applied, in which the user chooses from the brainstorm outputted items. The user choice is entered from the frontend to the backend and saved in a format that can be outputted back into a prompt for subsequent input to the machine learning model. The user view may be updated to reflect the saved changes.

In still some implementations, a mixed automatic/manual choose agent (not shown) may be applied. In these situations, the next instructions include considering the choices from both the user (manual) and the machine learning model (automatic) and making a final choice. A next instruction is for the machine learning model to choose between the automatic (machine learning model) chosen item and the user chosen item. If both items are the same, the chosen item is selected. If both items are different, the final choice instruction may include criteria to be used to make the final choice during execution of the task.

As shown in FIG. 4B, the CoT may include iterative type agents. The example CoT includes a repeat agent 440. Where an agent is to be repeated the backend may execute an agent multiple times. Repetition of the agent may include multiple executions of sub-instructions in the CoT. The next agent in the CoT is saved in the database and may be provided as an updated view to the user.

Loop over agents 442 may also be included in the CoT, for example, employing an input array. The backend may loop over various inputs and execute the operations for each element of the input array. The backend builds a next prompt for the loop over steps based, at least in part, on one or more previous instructions outputs by the machine learning model in the CoT. The next prompt is input into the machine learning model, which executes the creation of the next instruction based on the inputted prompt. The next agent in the CoT is saved in the database and may be provided as an updated view to the user.

As shown in FIG. 4C, in some implementations, external API's 460 and/or external services 462 may be employed in the meta-prompt CoT process. Such external API's and services are separate from the CoT meta-prompting system components of the frontend, backend, machine learning model, and database. Such external resources may be accessed via a network (such as network 130 in FIG. 1). For example, a search the web agent 464 may be included in the CoT, such as an agent configured to use an external search engine to use search results in building a prompt, task description, context, guidelines, etc. The backend may send a call to the search API for the target information. The received results may be saved in the database and may be provided to the user as an updated view.

In some implementations, other external resources and/or services may be employed to perform various other operations 466 that are different from a search request. Such other agent may be specific to the target task and CoT. The received results may be saved in the database and may be provided to the user as an updated view.

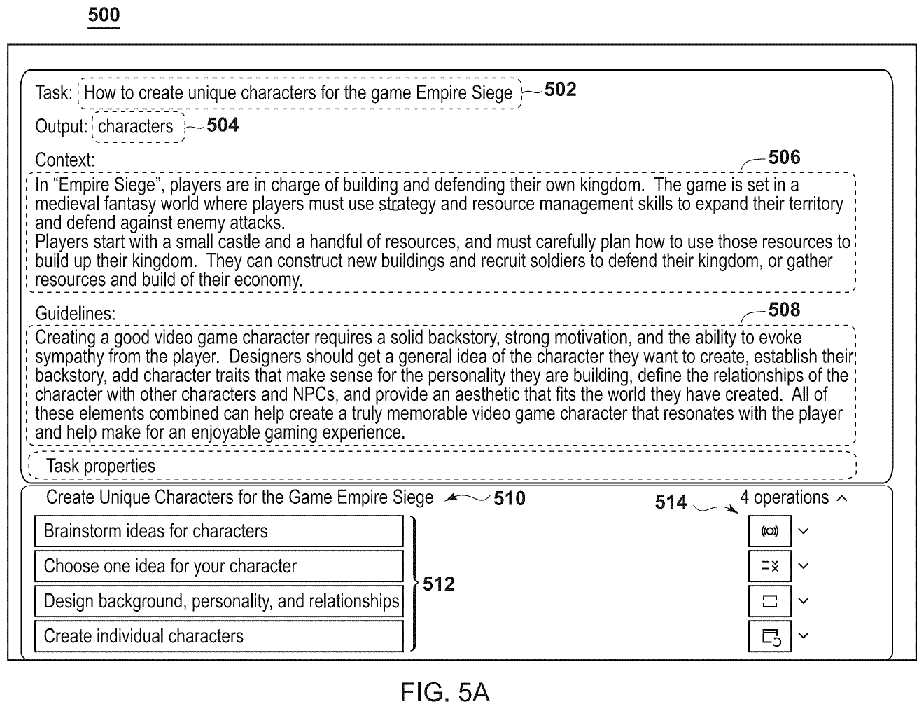

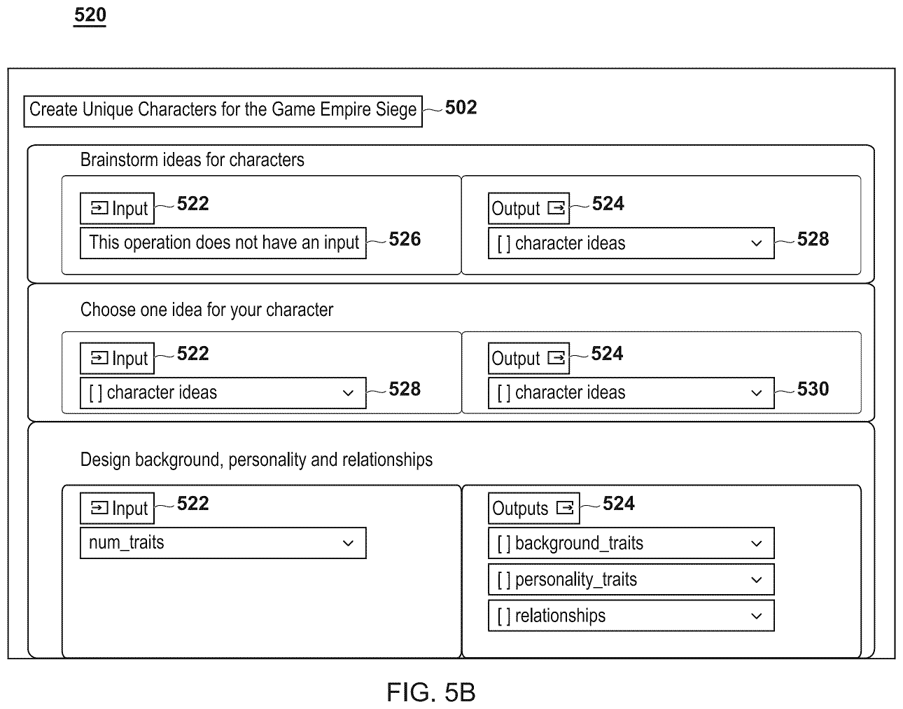

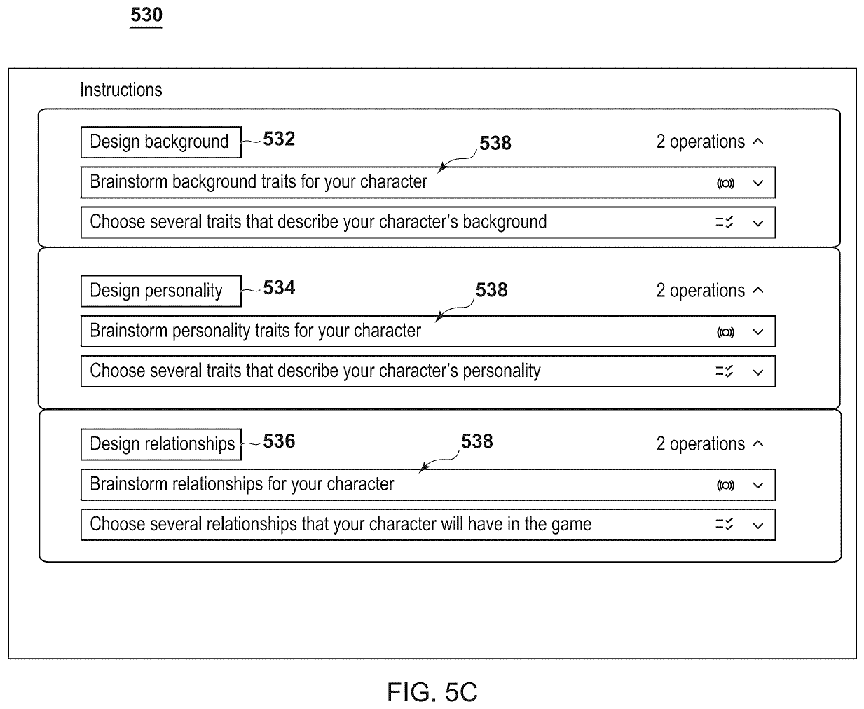

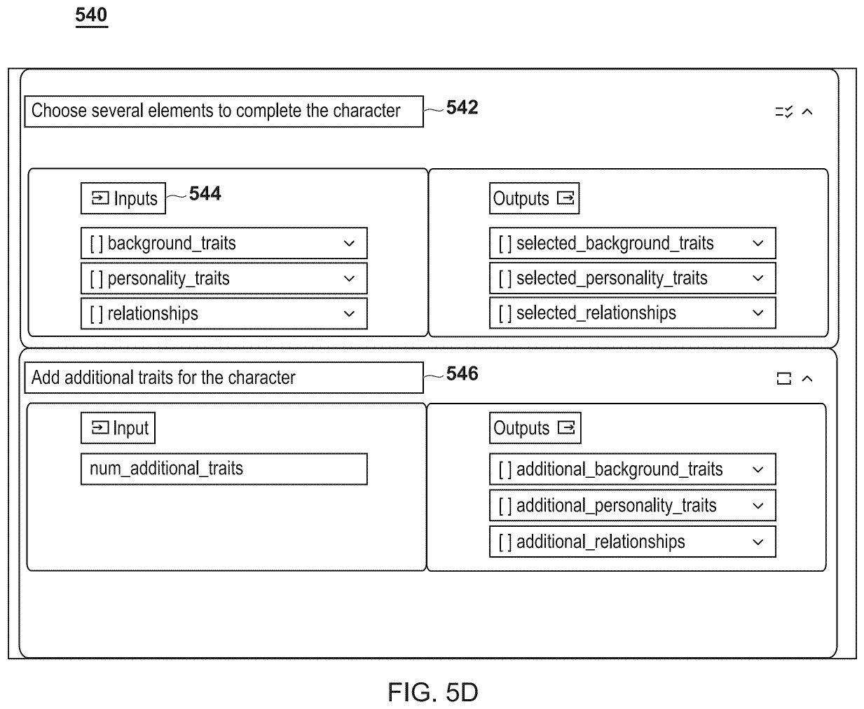

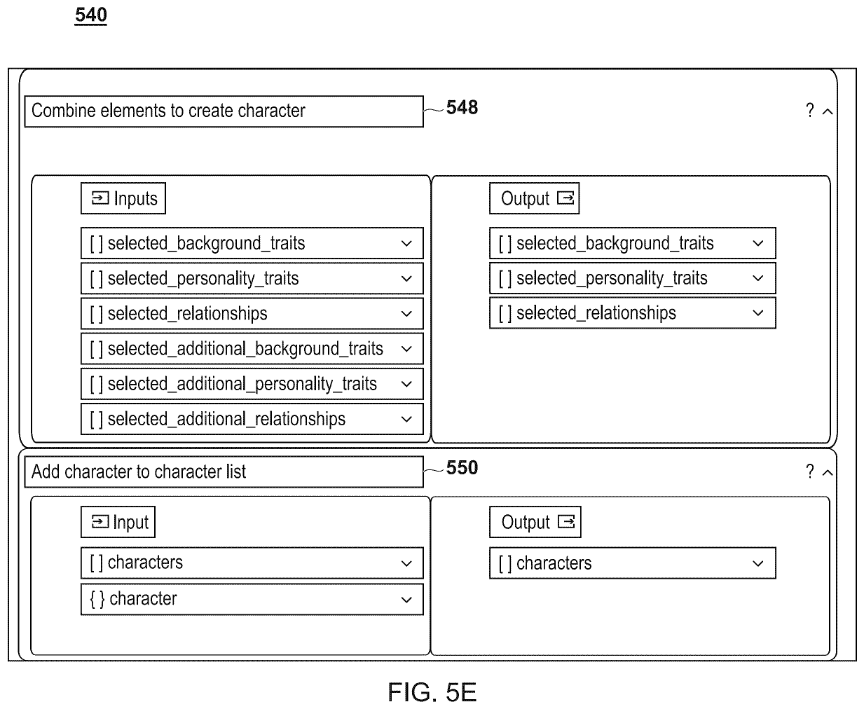

FIGS. 5A-5E show a graphical user interface (GUI) 500 to display an example of a CoT generated via the CoT meta-prompting process. The GUI may be displayed on the frontend (such as user interface 108 and display 106 in FIG. 1) for the user to view, receive, and enter data of the CoT meta-prompt process by interfacing with the backend (such as 114 in FIG. 1) and/or database (such as storage 128 in FIG. 1). The GUI may include any one or more of the pages shown in FIGS. 5A-5E, including one or more of the data fields depicted or may include additional data fields.

In some implementations, the CoT meta-prompting system may be fully automated after a user enters information for the initiation prompt. The GUI may simply consist of a page to enter various task information to build the initiation prompt, as shown in FIG. 5A, and the CoT meta-prompting system performs the process of creating the CoT and/or using the completed CoT to perform the task without providing the user with visibility of the backend processes. In these implementations, the user may view the resulting completed task performed via the created CoT.

As shown in FIG. 5A, task information includes a task description 502 entered in the user interface 500 for inclusion in an initiation prompt. A target output 504 may also be entered for the initiation prompt. In some implementations, context information 506 and guidelines 508 may be also entered to the user interface.

The initiation prompt may also include one or more CoT meta-prompting rules including producing step by step instructions for the task, which are represented in a given model, and output adheres to a given data exchange format. In some implementations, the CoT meta-prompting rules may be built into the system processes and not required to be entered by the user via the user interface.

Once the initiation prompt is entered, a basic CoT 510 generated via the CoT meta-prompt process is displayed on a portion of the user interface. The basic CoT 510 includes multiple agents 512, each agent having at least one action. The example basic CoT shown includes four agents with an action (four actions total). Data types of actions 514 in each instruction are summarized by symbols.

In FIG. 5B shows a construction detail page 520 of the GUI with each input (if any) 522 and output 524 used to create the CoT for each instruction 512. In some implementations, multiple inputs may be received, each from different sources, such as a previous output or a user entering an input. The machine learning model may decide which of the multiple inputs to use in creating the next instructions. In some implementations, greater weight may be applied to an input from a particular source, such as a user in determining which input to use.

Each next agent after a first instruction and/or operation, may use one or more previous outputs 524 as an input 522 to create the next agent. An agent may be identified by a base property, such as an identifier, name, and/or description. For example, the instruction step in this example CoT, “choose one idea for your character” uses the previous output having a base property of “character_ideas,” as an input. The step results in selection of a character idea as an output, “character_idea.” The first instruction, “brainstorm ideas for characters” uses the initiation prompt as an input rather than using a previous instruction output as an input 526.

The construction detail page 530 of the GUI as shown in FIG. 5C, shows splitting and expansion of an agent in the basic CoT 510 shown in FIG. 5A. The instruction “design background, personality, and relationships” is split into separate operations, “design background” 532, “design personality” 534, and “design relationships” 536. Each of the operations are expanded to include sub-instructions 538 with the operations, “brainstorm” and “choose”.

The construction detail page 540 of the GUI as shown in FIGS. 5D and 5E, depicts expansion of the final instruction of the basic CoT 510 that results in the terminating CoT output, “create individual characters” to form sub-instructions. In FIG. 5D the final instruction is expanded to include, “choose several elements to complete the character” 542. Inputs 544 include the character element outputs, “background_traits”, personality_traits “, and “relationships” from the prior sub-operations 538 (shown in FIG. 5C). Selected elements are outputted. A sub-instruction “add additional elements for the character” 546 is also provided to get more granular in the details of the character.

FIG. 5E shows more to the construction detail page 540, in which all of the variables of the CoT are displayed. Sub-instructions of the final instruction of “create individual characters” are provided as “combine elements to create character” 548. The selected elements that outputted in the prior sub-instructions 542 and 546 are used as inputs to form the character output. Final sub-instruction, “add character to character list” 550 completes the CoT.

A task properties page of the GUI may be provided to show outputs of each instruction, including sub-instructions, of the CoT. Various types of data structures, such as arrays, objects, numbers, strings, Booleans, and other data types, for each variable may be shown. For example, an array properties list may be designated by square bracket symbols, “[ ]”, an object properties list may be designated by curly bracket symbols, “{ }”, and a list of number properties list may be designated by a symbol of miniature numbers “123”.

An analysis and modifications page of the GUI may be provided to provide a user with elements to perform various features to assist in modifying the CoT. The user may trigger an analysis of relationships between the task properties of the outputs in each instruction, such as task properties, to find certain patterns. An analysis of dependencies between operations may also be triggered by the user. Found dependencies may be listed according to identifiers for each instruction operation. If deemed necessary, inputs and/or outputs may be adjusted according to the determined dependencies between particular objects. This feature may serve as a checkpoint for a user to make sure inputs are correct in a CoT, or for manual entering of inputs from prior outputs. For example, if a particular agent depends on a previous output of a previous agent, that previous output may be fed as input in the prompt for the machine learning model to create the particular agent. In addition, task properties may be enhanced by a user triggering an augment task properties function. All features may be triggered with an all of the above element. Activating of any of the elements on the analysis and modifications page may trigger the backend to build a prompt for the machine learning model to perform the feature.

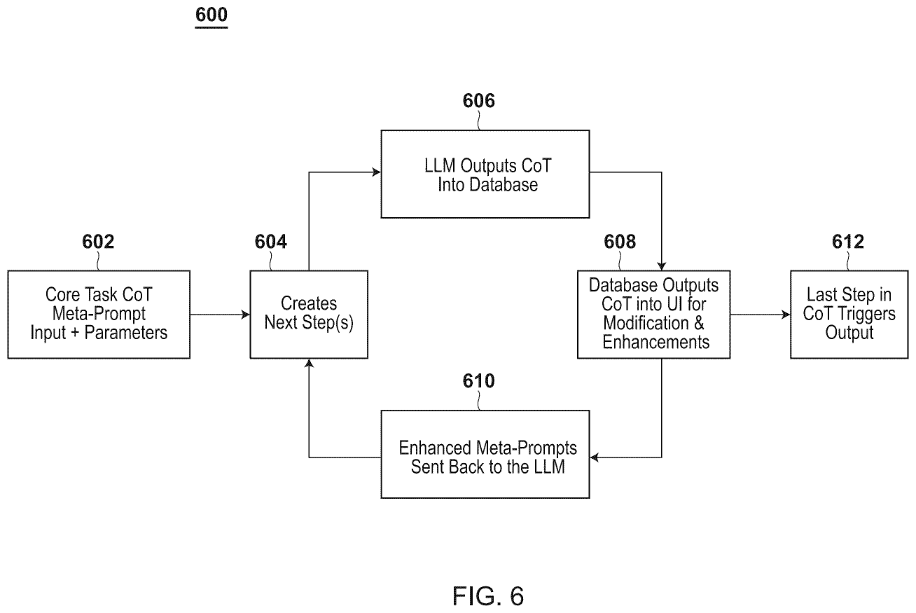

FIG. 6 shows iterative CoT meta-prompt process 600 to enhance agents and produce a finalized CoT chain. An initiation prompt, including task information, such as a task description, target output, context, and guidelines, along with CoT rules (parameters) are inputted 602 to the machine learning model. The machine learning model creates 604 a next instruction step of the CoT chain and outputs 606 the growing CoT chain to a database. In some implementations, the machine learning model output a completed basic CoT that includes more than one instruction step, each with one or more actions, to the database.

The database is accessed by a user of a frontend to view the CoT (completed basic CoT, last instruction added, or growing CoT) and enter requests for modifications and/or enhancements of any agents. Any enhancements and/or modifications requested by the user is collected and processed by the backend (e.g., build a prompt to address the enhancement or modification) and sent back 610 to the machine learning model. The machine learning model creates agents to address any enhancements or modifications and the process continues to store 606 the changes in the database. If there are no requested modifications and/or enhancements for an agent, the machine learning model progresses to create a next agent or finalizes the CoT if there are no more agents to be created for the CoT, e.g., if a level of difficulty has been reached for the CoT. The completion of the terminal instruction triggers completion and finalization of the CoT chain, which is outputted 612 and/or saved in the database.

FIG. 8 shows a computer device that may be employed to perform at least some of the CoT meta-prompt processes described. For example, computing device 700 may be used to implement backend 114 of FIG. 1. In some implementations, computing device 700 may also include functionalities of frontend 104 of FIG. 1 and/or storage 128 of FIG. 1.

Computing device 700 may include a processor 702, an operating system 704, a memory 706, and an input/output interface 708. The processor 702, which may include one or more processors, may be user to implement various functions and features described herein, as well as to perform implementations described herein. While processor 702 is described as performing implementations herein, any suitable component or combination of components of computing device 700 or suitable processor or processors associated with the computing device 700 may perform the steps described. Implementations described herein may be carried out on a user device, server, or combination of both.

Computing device 700 also includes a CoT meta-prompt builder module 710, which may be stored on memory 706 or other suitable storage location or computer-readable medium. The CoT meta-prompt builder 710 may be a software application that provides instructions that enable the processor 702 to perform the functions described herein and other functions, such as building prompts to input to the machine learning model in creating the CoT, such as an initiation prompt, next step prompts, final prompts, and enhancement operations prompts.

The components of computing device 800 may be implemented by one or more processors 702 or any combination of hardware devices, as well as any combination of hardware, software, firmware, etc. For ease of illustrations, FIG. 8 shows one block for each processor 802, operating system 804, memory 806, and I/O interface 808 and CoT meta-prompt builder 810. These blocks may represent multiple processors, operating systems, memories, I/O interfaces, and software applications. In various implementations, the computing device 800 may not have all of the components shown and/or may have other elements including other types of components instead of, or in addition to those shown herein.

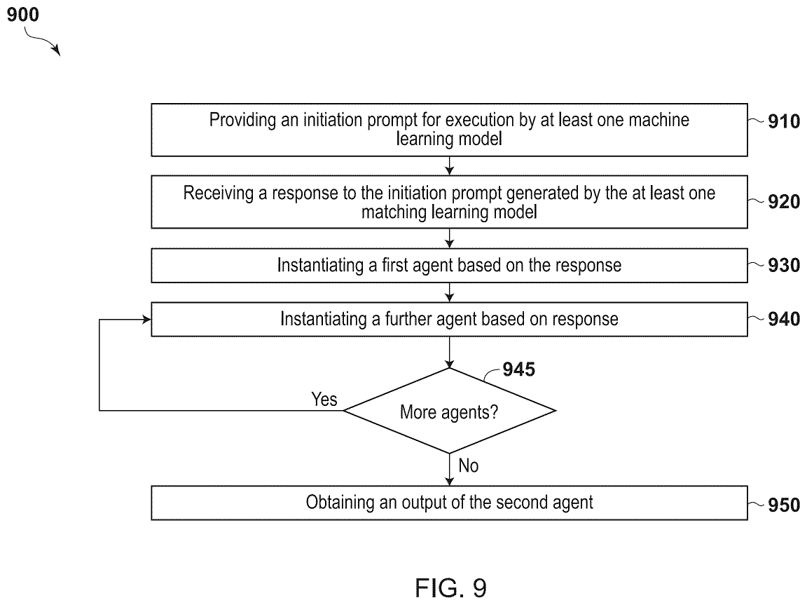

FIG. 9 shows a flowchart diagram of an example method of performing a task using a chain of thought model in accordance with at least some embodiments. Method 900 may be carried out, for example, by environment 100 of FIG. 1.

At block 910, the initiation prompt 700 for execution by at least one machine learning model is provided, as described elsewhere herein. For instance, the initiation prompt may be provided by the frontend 104 or backend 114 to the machine learning model 120. The at least one machine learning model may be the machine learning model 120, as described elsewhere herein. The initiation prompt 700 includes an objective and instructions to define a plurality of agents for achieving the objective, and an arrangement of the plurality of agents. The objective is a task or desired output to be achieved.

At block 920 a response to the initiation prompt 700 generated by the at least one machine learning model is received. For instance, the at least one machine learning model may execute to generate the response, and return the response to the backend and/or frontend. The response defines, at least initially, the plurality of agents for achieving the objective and the arrangement of the plurality of agents. That is, the response includes the CoT chain that outlines the plurality of agents for achieving the objective. The plurality of agents define the actions required to achieve the objective. The arrangement of the plurality of agents generally is in the form of a hypergraph or other structure, as described herein. For instance, the hypergraph includes a plurality of notes and a plurality of edges. The plurality of nodes represent the plurality of agents. The plurality of edges represent the data connections between the plurality of agents. The hypergraph is optionally a directed hypergraph, and preferably a directed acyclic hypergraph.

In some cases, prior to receiving the response, a preliminary response may be received, requesting further input or refinement. The preliminary response includes an intermediate prompt which may contain an indication of additional data that is requested by the at least one machine learning model prior to generation of the response. The user 302 may be prompted to review the preliminary response and to provide an input including some or all of the additional data. Alternatively, or in addition, the backend or frontend may retrieve and/or supply some or all of the additional data. The intermediate prompt is updated based on the input from the user 302 prior to providing it to the at least one machine learning model. As an example, the user 302 may provide specific guidelines for a task. In some cases, the backend 114 builds a prompt (or may enlist a machine learning model) directing the at least one machine learning model (which may be different from the model that generates the intermediate prompt) to generate specific guidelines for a task or to provide other details relating to the intermediate prompt. The machine learning model returns the guidelines to the backend 114. The backend 114 returns the guidelines to the frontend 104. The user 302 can then review the guidelines, and accept the generated guidelines, update some or all of the guidelines, or revise the request for guidelines.

In some cases, at least one of plurality of agents, when executed, is configured to retrieve data from an API endpoint. For example, the frontend 14 may make an API call 316 to the backend 114 for data to be included in the updated intermediate prompt.

At block 930, a first agent is instantiated based on the response. The first agent is represented by a first node of the plurality of nodes in the hypergraph and represents a particular agent required to achieve the objective. Instantiating the first agent may include providing the first prompt to the at least one machine learning model for execution, and receiving a first output of the first agent generated by the at least one machine learning model. In some cases, the first prompt is generated based on a predetermined prompt structure. The first output of the first agent may be in a structured format, as described herein, and the structured format may be defined in the initiation prompt 700. The first output may include, for example, a data field. In some cases, an input from the user 302 may be requested that is associated with the data field, and the first output may be updated based on the input from the user.

At block 940, a further (e.g., second, third, etc.) agent is instantiated based on the response. The further agent is represented by a further node of the plurality of nodes in the hypergraph and represents another particular agent required to achieve the objective. In some cases, the further agent comprises a further prompt for the at least one machine learning model. Instantiating the further agent may include providing the further prompt to the at least one machine learning model for execution, and receiving the output of the further agent generated by the at least one machine learning model. In at least some cases, instantiating the further agent includes providing the further prompt and one or more output of the first agent and/or other agents to the at least one machine learning model.

At block 945, a determination is made as to whether there are further agents to be instantiated and, if so, the method returns to block 940. Otherwise, the method proceeds to block 950.

At block 950, an output of the chain of thought model is obtained from an output node representing an output agent.

As noted, the plurality of agents can include the first agent, a second agent, and at least one additional agent. Accordingly, in some cases, for a subset of the at least one additional agent, the method 900 includes instantiating each agent of the subset and receiving a respective output. This can include providing at least one output of the first agent or another agent of the subset that precedes the respective agent in the hypergraph.

The initiation prompt 700 can be structured in a manner such that rather than being a generic prompt, more specific information is added to each prompt to improve effectiveness. This may be referred to as COT persona prompting. For example, a CoT meta-prompt can be generated that includes:
Operation Description Properties:
   Name
   Title
   Description
      These fields are then used in a subsequent prompt to generate a ‘persona’ prompt. In general, any prompt may be, or incorporate, a persona prompt. A persona pattern prompt is then generated using information in the next prompt as follows:
“Act like a “job type“ ”
   such that when an agent is being, defined it has additional persona information in it. When the user 302 performs “generate a prompt”, the LLM decides what “job” is appropriate to solve the task. This can be implemented by requiring user choice or automatic choice. Guidance can be provided at the start of the process regarding which jobs are appropriate for which prompting roles.

When using an LLM to create guidelines, a generic concept for guiding the development of the prompt may be used. The CoT generates:
Operation title
Operation Guidelines
   The generic concept can be further augmented by including the following:
an Operation O
a Task Description D
Guidelines G
   The LLM reads O and D and uses that information to revise the guidelines G to G′. This is known as guideline augmentation prompting.

While directed acyclic hypergraphs have been described, hypergraphs may be realized and visualized in explicit CoT graphs. For example, a language such as Mermaid Class Output can be used, or other languages known to the system can be used, to generate the hypergraph. The graph as generated outlines each step in a visualized CoT. The main visualized CoT graph can be decomposed so that individual nodes are replaced by subgraphs. Each subgraph can be executed independently. The subgraphs can then be recombined to generate a very large CoT.

LLM operations may also be enhanced. After generating a CoT, the LLM may be used to enhance the properties of an operation defined in the CoT. The CoT meta-prompt can include an instruction to ask the LLM to provide additional information required to effectively build an agent for the particular operation. Example of the additional information include, the type operations (e.g., provide the LLM with a set of operations to choose from), a description of the operation, instructions to carry out the operation (that can be used as a prompt for the LLM).

Operation output type matching may also be used. In an example, the output is required to generate a “protagonist”. The LLM recognizes that it needs to be a type of “protagonist” which is a subclass of “character”. A prompt may include:
“Given that I want this object, give me a JSON representation of such a character.”
   When prompted at execution level, it is demanded that the LLM respects the JSON schema for a definition of a character.

Different data structures can be used as part of the described processes, with arrays being one example. After generation of an array data structure, the user 302 is able to view the results. The user 302 can ask for more, and the backend or machine learning model, or another tool, decides how many times to iterate the process of generating the array. This is known as redundant array generation. Redundant array generation can be used in cases where there is a list of option, and if the user 302 does not like any of the presented options, another array can be generated. This approach can be applied to more complex data types, including anything that encompasses a list.

Various examples of aspects of the disclosure are described as numbered Example Clauses (1, 2, 3, etc.) for convenience. These are provided as examples, and not to limit the subject technology.

Example Clause 1: A method of performing a task using a chain of thought model, the method may include: providing an initiation prompt for execution by at least one machine learning model, the initiation prompt including an objective and instructions to define a plurality of agents for achieving the objective and an arrangement of the plurality of agents; receiving a response to the initiation prompt generated by the at least one machine learning model, the response defining the plurality of agents and the arrangement of the plurality of agents, where the arrangement may include a hypergraph in which a plurality of nodes represents the plurality of agents, respectively, and in which a plurality of edges represents data connections between the plurality of agents; instantiating a first agent based on the response, the first agent represented by a first node of the plurality of nodes in the hypergraph; instantiating a second agent based on response, the second agent represented by a second node of the plurality of nodes in the hypergraph; and obtaining an output of the second agent.

Example Clause 2: The method of Example Clause 1, prior to receiving the response, receiving a preliminary response, where the preliminary response to the initiation prompt may include an intermediate prompt, further may include providing the intermediate prompt to the at least one machine learning model.

Example Clause 3: The method of Example Clause 2, further may include requesting a user input based on the preliminary response, and updating the intermediate prompt based on the user input prior to providing the intermediate prompt to the at least one machine learning model.

Example Clause 4: The method of Example Clause 2 or Example Claus 3, where the at least one machine learning model may include a first model and a second model, where the response is generated by the first model, and where a second response is generated by the second model.

Example Clause 5: The method of any one of Example Clauses 1-4, where at least one of the plurality of agents, when executed, is configured to retrieve data from an API endpoint.

Example Clause 6: The method of any one of Example Clauses 1-5, where the first agent may include a first prompt for the at least one machine learning model, and where instantiating the first agent may include: providing the first prompt to the at least one machine learning model for execution; and receiving a first output of the first agent generated by the at least one machine learning model.

Example Clause 7: The method of Example Clause 6, where the second agent may include a second prompt for the at least one machine learning model, and where instantiating the second agent may include: providing the second prompt to the at least one machine learning model for execution; and receiving the output of the second agent generated by the at least one machine learning model.

Example Clause 8: The method of Example Clause 7, where instantiating the second agent further may include providing the second prompt and the first output of the first agent to the at least one machine learning model.

Example Clause 9: The method of any one of Example Clauses 1-8, further may include instantiating a third agent of the plurality of agents based on the response, the third agent represented by a third node of the plurality of nodes in the hypergraph.

Example Clause 10: The method of Example Clause 8, where the third agent may include a third prompt for the at least one machine learning model, where instantiating the third agent may include: providing the third prompt to the at least one machine learning model for execution; and receiving a third output of the third agent generated by the at least one machine learning model.

Example Clause 11: The method of Example Clause 10, where instantiating the second agent further may include providing the third output of the third agent to the at least one machine learning model.

Example Clause 12: The method of Example Clause 10 or Example Clause 11, where the plurality of agents may include the first agent, the second agent and at least one additional agent, further may include, for a subset of the at least one additional agent, instantiating each agent of the subset and receiving a respective output.

Example Clause 13: The method of any one of Example Clauses 10-12, where instantiating the respective agent of the subset may include providing at least one output of the first agent or another agent of the subset that precedes the respective agent in the hypergraph.

Example Clause 14: The method of Example Clause 13, where the first output may include a data field, further may include: requesting a user input associated with the data field, and updating the first output based on the user input.

Example Clause 15: The method of any one of Example Clauses 6-14, where the first output of the first agent is in a structured format.

Example Clause 16: The method of Example Clause 15, where the structured format is defined in the initiation prompt.

Example Clause 17: The method of any one of Example Clauses 1-16, where the first prompt is generated based on a predetermined prompt structure.

Example Clause 18: The method of Example Clause 17, where the hypergraph is a directed hypergraph.

Example Clause 19: The method of any one of Example Clauses 6-16, where the directed hypergraph is a directed acyclic hypergraph.

Example Clause 20: The method of any one of Example Clauses 1-19, the method further may include, prior to providing the initiation prompt, retraining the at least one machine learning model using a database of prior responses.

Example Clause 21: The method of Example Clause 20, where the providing may include the at least one machine learning model generating the initiation prompt.

Example Clause 22: An apparatus for performing a task using a chain of thought model, the apparatus may include: a memory; and a processor configured to: provide an initiation prompt for execution by at least one machine learning model, the initiation prompt including an objective and instructions to define a plurality of agents for achieving the objective and an arrangement of the plurality of agents; receive a response to the initiation prompt generated by the at least one machine learning model, the response defining the plurality of agents and the arrangement of the plurality of agents, where the arrangement may include a hypergraph in which a plurality of nodes represents the plurality of agents, respectively, and in which a plurality of edges represents data connections between the plurality of agents; instantiate a first agent based on the response, the first agent represented by a first node of the plurality of nodes in the hypergraph; instantiate a second agent based on response, the second agent represented by a second node of the plurality of nodes in the hypergraph; and obtain an output of the second agent.

Example Clause 23: A system for performing a task using a chain of thought model, the system may include: a frontend; a backend; and a machine learning model processor, where the backend is configured to provide an initiation prompt for execution by at least one machine learning model, the initiation prompt including an objective and instructions to define a plurality of agents for achieving the objective and an arrangement of the plurality of agents; where the machine learning model processor is configured to generate a response to the initiation prompt, and provide the response to the backend; where the backend and the machine learning model processor are further configured to instantiate a first agent based on the response, the first agent represented by a first node of the plurality of nodes in the hypergraph, and instantiate a second agent based on response, the second agent represented by a second node of the plurality of nodes in the hypergraph; and where the backend is configured to obtain an output of the second agent.

Example Clause 24: One or more tangible machine-readable media including logic encoded in the one or more tangible machine-readable media for execution by one or more processors and when executed operable to perform steps may include: using an artificial intelligence (AI) language model, generating a series of sequential agents represented as a chain of thought (CoT) model to perform a task, where generating the series of sequential agents may include: building an initiation prompt specifying that an output is in a particular format readable by a program that executes the agents building a series of next prompts subsequent to the initiation prompt by selecting in a particular order of stored generic prompts of certain types and/or executing particular application programming interface (API) calls; and feeding the initiation prompt and the series of next prompts into a language model to execute and to create the series of sequential agents, where each input in an agent includes a next prompt based, at least in part, on selecting one or more preceding outputs of the agents in the CoT model.

Example Clause 25: The one or more tangible machine-readable media of Example Clause 24, where the initiation prompt further specifies that the agent outputs are represented in a particular data structure.

Example Clause 26: The one or more tangible machine-readable media of Example Clause 24 or Example Clause 25, where each agent may include at least one base property including one or more of an identifier, a name, or a description.

Example Clause 27: The one or more tangible machine-readable media of any one of Example Clauses 24-26, where the steps further may include executing the completed series of sequential agents to perform the task.

Example Clause 28: The one or more tangible machine-readable media of any one of Example Clauses 24-27, where the AI language model includes Generative Pre-trained Transformer 3 (GPT3).

Example Clause 29: The one or more tangible machine-readable media of any one of Example Clauses 24-28, where each sequential chain of thought output increases in granularity of detail and relates to and of the previous outputs of the series of sequential agents.

Example Clause 30: The one or more tangible machine-readable media of any one of Example Clauses 24-29, where the steps further may include receiving user input to modify one or more agents for one or more of the chain of thought outputs.

Example Clause 31: The one or more tangible machine-readable media of any one of Example Clauses 24-30, where the API call is to an external resource to search for and retrieve information.

Example Clause 32: The one or more tangible machine-readable media of any one of Example Clauses 24-31, where at least one of the prompts is a choose type in which an item is chosen from a list of items generated in a previous chain of thought output.

Example Clause 33: One or more tangible machine-readable media including logic encoded in the one or more tangible machine-readable media for execution by one or more processors and when executed operable to perform steps may include: generating a series of sequential agents represented as a chain of thought model with an artificial intelligence (AI) language model to perform a task, where each agent includes: a description, inputs and outputs, where each agent prior to a terminating agent specifies an objective to generate inputs for a subsequent agent; where each agent subsequent to an initiation agent is based on a preceding chain of thought output; and where the agents are output in a particular format readable by a program that can execute those agents.

Example Clause 34: An initiation CoT meta prompt method in which: step by step instructions for a task are outlined; an algorithm is generated by a large language model and represented as the CoT model of Example Clause 33, the CoT model including a set of agents to complete the task; and an output is returned in a data format usable for a program to execute and perform a task.

Example Clause 35: A method for generating a chain of thought content using an artificial intelligence (AI) system, the method may include: receiving an initiation prompt designed to be input to the AI system; generating subsequent prompts, where each subsequent prompt is generated, at least in part, based on a prior output in the chain of thought technique; and submitting at least one of the subsequent prompts to the AI system to generate the chain of thought content.

Any suitable programming language can be used to implement the routines of particular implementations, including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular implementations. In some particular implementations, multiple steps shown as sequential in this description can be performed in parallel, at the same time.

Particular implementations may be carried out in a non-transitory processor-readable storage device for use by or in connection with the instruction execution system, apparatus, system, or device. Particular implementations can be carried out in the form of control logic in software or hardware or a combination of both. The control logic, when executed by one or more processors, may be operable to perform that which is described in particular implementations, For example, a tangible medium such as a hardware storage device can be used to store the control logic, which can include executable instructions.

Particular implementations may be carried out by using a programmed general purpose digital computer, by using application specific integrated circuits, programmable logic devices, field programmable gate arrays, optical, chemical, biological, quantum or nanoengineered systems, etc. Other components and mechanisms may be used. In general, the functions of particular implementations can be achieved by any means as is known in the art. Distributed networked systems, components, and/or circuits can be used. Cloud computing or cloud services can be employed. Communication, or transfer, or data may be wired, wireless, or by any other means.

It will also be appreciated that one or more of the elements depicted in the drawings/figures can also be implemented in separated or integrated manner, or even removed or rendered as inoperable in certain cases, as is useful in accordance with a particular application. It is also within the spirit and scope to implement a program or code that can be stored in a machine-readable medium to permit a computing device to perform any of the methods described above.

A “processor” includes any suitable hardware and/or software system, mechanism, or component that processes data, signals, or other information. A processor can include a system within a general-purpose central processing unit, multiple processing units, dedicated circuitry for achieving functionality or other systems. Processing need not be limited to geographic location, or have temporal limitations. For example, a processor can perform its functions in “real time,” “offline,” in a “batch mode,” etc. Portions of processing can be performed at different times and at different locations, by different (or the same) processing systems. Examples of processing systems can include servers, clients, end user devices, routers, switches, networked storage, etc. A computer may be any processor in communication with a memory. The memory may be any suitable processor-readable storage medium, such as a random-access memory (RAM), read-only memory (ROM), magnetic or optical disk, or other tangible media suitable for storing instructions for execution by the processor.

As used in the description herein and throughout the claims, the terms, “a”, “an,” and “the” include plural references unless the context clearly dictates otherwise. Also, as used in the description herein and throughout the claims, the meaning of “in” includes “in” and “on” unless the context clearly dictates otherwise.

Thus, while particular implementations have been described herein, latitudes of modification, various changes, and substitutions are intended in the foregoing disclosures, and it will be appreciated that in some instances some features of particular implementations will be employed without a corresponding use of other features without departing from the scope and spirit as set forth. Therefore, many modifications may be made to adapt a particular situation or material to the essential scope and spirit.

What is claimed is:

1. A method of performing a task using a chain of thought model, the method comprising:
providing an initiation prompt for execution by at least one machine learning model, the initiation prompt including an objective and instructions to define a plurality of agents for achieving the objective and an arrangement of the plurality of agents;
receiving a response to the initiation prompt generated by the at least one machine learning model, the response defining the plurality of agents and the arrangement of the plurality of agents, wherein the arrangement comprises a hypergraph in which a plurality of nodes represents the plurality of agents, respectively, and in which a plurality of edges represents data connections between the plurality of agents;
instantiating a first agent based on the response, the first agent represented by a first node of the plurality of nodes in the hypergraph;
instantiating a second agent based on response, the second agent represented by a second node of the plurality of nodes in the hypergraph; and
obtaining an output of the second agent.

2. The method of claim 1, prior to receiving the response, receiving a preliminary response, wherein the preliminary response to the initiation prompt comprises an intermediate prompt, further comprising providing the intermediate prompt to the at least one machine learning model.

3. The method of claim 2, further comprising requesting a user input based on the preliminary response, and updating the intermediate prompt based on the user input prior to providing the intermediate prompt to the at least one machine learning model.

4. The method of claim 2, wherein the at least one machine learning model comprises a first model and a second model, wherein the response is generated by the first model, and wherein a second response is generated by the second model.

5. The method of claim 1, wherein at least one of the plurality of agents, when executed, is configured to retrieve data from an API endpoint.

6. The method of claim 1, wherein the first agent comprises a first prompt for the at least one machine learning model, and wherein instantiating the first agent comprises:
providing the first prompt to the at least one machine learning model for execution; and
receiving a first output of the first agent generated by the at least one machine learning model.

7. The method of claim 6, wherein the second agent comprises a second prompt for the at least one machine learning model, and wherein instantiating the second agent comprises:
providing the second prompt to the at least one machine learning model for execution; and
receiving the output of the second agent generated by the at least one machine learning model.

8. The method of claim 7, wherein instantiating the second agent further comprises providing the second prompt and the first output of the first agent to the at least one machine learning model.

9. The method of claim 6, wherein the first output comprises a data field, further comprising: requesting a user input associated with the data field, and updating the first output based on the user input.

10. The method of claim 8, further comprising instantiating a third agent of the plurality of agents based on the response, the third agent represented by a third node of the plurality of nodes in the hypergraph.

11. The method of claim 10, wherein the third agent comprises a third prompt for the at least one machine learning model, wherein instantiating the third agent comprises: providing the third prompt to the at least one machine learning model for execution; and receiving a third output of the third agent generated by the at least one machine learning model.

12. The method of claim 10, wherein instantiating the second agent further comprises providing the third output of the third agent to the at least one machine learning model.

13. The method of claim 8, wherein the plurality of agents comprises the first agent, the second agent and at least one additional agent, further comprising, for a subset of the at least one additional agent, instantiating each agent of the subset and receiving a respective output.

14. The method of claim 13, wherein instantiating the respective agent of the subset comprises providing at least one output of the first agent or another agent of the subset that precedes the respective agent in the hypergraph.

15. The method of claim 6, wherein the first output of the first agent is in a structured format, wherein the structured format is defined in the initiation prompt.

16. The method of claim 1, wherein the hypergraph is a directed hypergraph, wherein the directed hypergraph is a directed acyclic hypergraph.

17. The method of claim 6, wherein the first prompt is generated based on a predetermined prompt structure.

18. The method of claim 1, the method further comprising, prior to providing the initiation prompt, retraining the at least one machine learning model using a database of prior responses.

19. An apparatus for performing a task using a chain of thought model, the apparatus comprising:
a memory; and
a processor configured to:
provide an initiation prompt for execution by at least one machine learning model, the initiation prompt including an objective and instructions to define a plurality of agents for achieving the objective and an arrangement of the plurality of agents;
receive a response to the initiation prompt generated by the at least one machine learning model, the response defining the plurality of agents and the arrangement of the plurality of agents, wherein the arrangement comprises a hypergraph in which a plurality of nodes represents the plurality of agents, respectively, and in which a plurality of edges represents data connections between the plurality of agents;
instantiate a first agent based on the response, the first agent represented by a first node of the plurality of nodes in the hypergraph;
instantiate a second agent based on response, the second agent represented by a second node of the plurality of nodes in the hypergraph; and
obtain an output of the second agent.

20. A system for performing a task using a chain of thought model, the system comprising:
a frontend;
a backend; and
a machine learning model processor,
wherein the backend is configured to provide an initiation prompt for execution by at least one machine learning model, the initiation prompt including an objective and instructions to define a plurality of agents for achieving the objective and an arrangement of the plurality of agents;
wherein the machine learning model processor is configured to generate a response to the initiation prompt, and provide the response to the backend;
wherein the backend and the machine learning model processor are further configured to
instantiate a first agent based on the response, the first agent represented by a first node of the plurality of nodes in the hypergraph, and instantiate a second agent based on response, the second agent represented by a second node of the plurality of nodes in the hypergraph; and
wherein the backend is configured to obtain an output of the second agent.
